(19) United States
(12) Patent Application Publication
(10) Pub. No.: US 2023/0375359 A1
(43) Pub. Date: Nov. 23, 2023

(54) USER INTERFACES FOR NAVIGATION

(71) Applicant: Apple Inc., Cupertino, CA (US)

(72) Inventors: Christopher B. FLEIZACH, Gilroy, CA (US); Allen WHEARRY, JR., San Jose, CA (US); Ryan N. DOUR, San Francisco, CA (US)

(21) Appl. No.: 18/319,394

(22) Filed: May 17, 2023

Related U.S. Application Data
(60) Provisional application No. 63/364,876, filed on May 17, 2022.

(51) Int. Cl. G01C 21/36

(52) U.S. Cl. CPC G01C 21/3667; G01C 21/3629

(57) ABSTRACT

In some embodiments, a computer system presents navigation directions from a first location to a second location. In some embodiments, if the current location of the computer system is different from the first location, the computer system presents audio and/or tactile feedback indicating distance and/or direction to the first location.

### CROSS-REFERENCE TO RELATED APPLICATIONS

This application claims the benefit of U.S. Provisional Application No. 63/364,876, filed May 17, 2022, the content of which is incorporated herein by reference in its entirety for all purposes.

### FIELD OF THE DISCLOSURE

This relates generally to user interfaces associated with locating a physical location at which navigation directions begin.

### BACKGROUND OF THE DISCLOSURE

User interaction with computer systems has increased significantly in recent years. These computer systems can be computer systems such as computers, tablet computers, televisions, multimedia computer systems, mobile computer systems, and the like.

In some circumstances, users may wish to use such computer systems to navigate from a first physical location to a second physical location. Enhancing the user's interactions with the computer system improves the user's experience with the computer system and decreases user interaction time, which is particularly important where input devices are battery-operated.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### SUMMARY OF THE DISCLOSURE

Some embodiments described in this disclosure are directed to one or more computer systems that present feedback indicating distance and/or direction to a navigation starting location. The full descriptions of the embodiments are provided in the Drawings and the Detailed Description, and it is understood that the Summary provided above does not limit the scope of the disclosure in any way.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction computer system with a touch-sensitive display in accordance with some embodiments.

FIG. 1B is a block diagram illustrating exemplary components for event handling in accordance with some embodiments.

FIG. 2 illustrates a portable multifunction computer system having a touch screen in accordance with some embodiments.

FIG. 3 is a block diagram of an exemplary multifunction computer system with a display and a touch-sensitive surface in accordance with some embodiments.

FIG. 4A illustrates an exemplary user interface for a menu of applications on a portable multifunction computer system in accordance with some embodiments.

FIG. 4B illustrates an exemplary user interface for a multifunction computer system with a touch-sensitive surface that is separate from the display in accordance with some embodiments.

FIG. 5A illustrates a personal computer system in accordance with some embodiments.

FIG. 5B is a block diagram illustrating a personal computer system in accordance with some embodiments.

FIGS. 5C-5D illustrate exemplary components of a personal computer system having a touch-sensitive display and intensity sensors in accordance with some embodiments.

FIGS. 5E-5H illustrate exemplary components and user interfaces of a personal computer system in accordance with some embodiments.

FIGS. 5I-5N provide a set of sample tactile output patterns that may be used, either individually or in combination, either as is or through one or more transformations (e.g., modulation, amplification, truncation, etc.), to create suitable haptic feedback in various scenarios and for various purposes, such as those mentioned above and those described with respect to the user interfaces and methods discussed herein.

FIGS. 6A-6K illustrate exemplary ways of presenting indications of distance and/or direction to a navigation starting location in accordance with some embodiments of the disclosure.

FIG. 7 is a flow diagram illustrating a method of presenting indications of distance and/or direction to a navigation starting location in accordance with some embodiments of the disclosure.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for computer systems that assist users in locating the beginning location of navigation directions from the beginning location to a destination location. Such techniques can reduce the cognitive burden on a user who uses such computer systems and/or wishes to control their use of such computer systems, and such technique can provide enhanced privacy or security. Further, such techniques can reduce processor and battery power otherwise wasted on redundant user inputs.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of computer systems, user interfaces for such computer systems, and associated processes for using such computer systems are described. In some embodiments, the computer system is a portable communications computer system, such as a mobile telephone, that also contains other functions, such as PDA and/or music player functions. Exemplary embodiments of portable multifunction computer systems include, without limitation, the iPhone®, iPod Touch®, and iPad® computer systems from Apple Inc. of Cupertino, California. Other portable computer systems, such as laptops or tablet computers with touch-sensitive surfaces (e.g., touch screen displays and/or touchpads), are, optionally, used. It should also be understood that, in some embodiments, the computer system is not a portable communications computer system, but is a desktop computer with a touch-sensitive surface (e.g., a touch screen display and/or a touchpad).

In the discussion that follows, a computer system that includes a display and a touch-sensitive surface is described. It should be understood, however, that the computer system optionally includes one or more other physical user-interface computer systems, such as a physical keyboard, a mouse, and/or a joystick.

The computer system typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the computer system optionally use at least one common physical user-interface computer system, such as the touch-sensitive surface. One or more functions of the touch-sensitive surface as well as corresponding information displayed on the computer system are, optionally, adjusted and/or varied from one application to the next and/or within a respective application. In this way, a common physical architecture (such as the touch-sensitive surface) of the computer system optionally supports the variety of applications with user interfaces that are intuitive and transparent to the user.

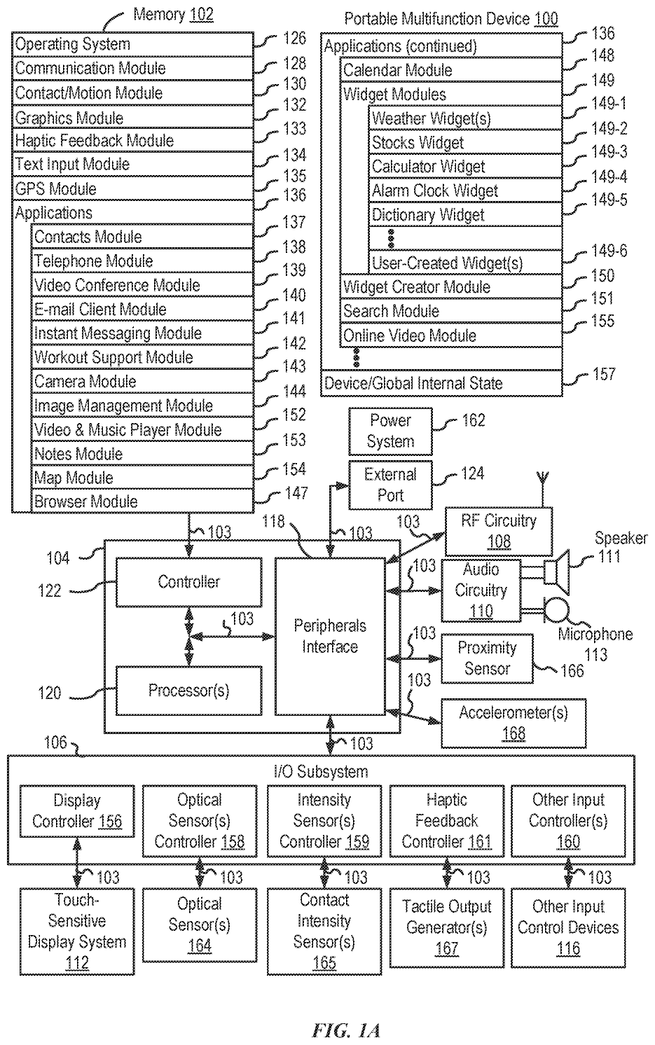

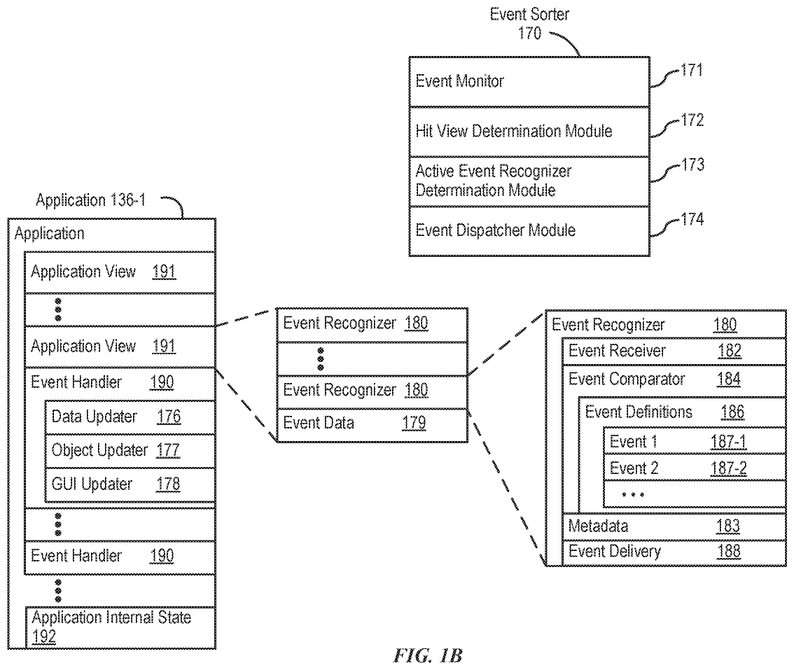

Attention is now directed toward embodiments of portable computer systems with touch-sensitive displays. FIG. 1A is a block diagram illustrating portable multifunction computer system 100 with touch-sensitive display system 112 in accordance with some embodiments. Touch-sensitive display 112 is sometimes called a “touch screen” for convenience and is sometimes known as or called a “touch-sensitive display system.” Computer system 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control computer systems 116, and external port 124. Computer system 100 optionally includes one or more optical sensors 164. Computer system 100 optionally includes one or more contact intensity sensors 165 for detecting intensity of contacts on computer system 100 (e.g., a touch-sensitive surface such as touch-sensitive display system 112 of computer system 100). Computer system 100 optionally includes one or more tactile output generators 167 for generating tactile outputs on computer system 100 (e.g., generating tactile outputs on a touch-sensitive surface such as touch-sensitive display system 112 of computer system 100 or touchpad 355 of computer system 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional computer system functionality that may otherwise not be accessible by the user on a reduced-size computer system with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a computer system relative to a previous position of the computer system, physical displacement of a component (e.g., a touch-sensitive surface) of a computer system relative to another component (e.g., housing) of the computer system, or displacement of the component relative to a center of mass of the computer system that will be detected by a user with the user's sense of touch. For example, in situations where the computer system or the component of the computer system is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the computer system or the component of the computer system. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the computer system or a component thereof that will generate the described sensory perception for a typical (or average) user.

It should be appreciated that computer system 100 is only one example of a portable multifunction computer system, and that computer system 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage computer systems, flash memory computer systems, or other non-volatile solid-state memory computer systems. Memory controller 122 optionally controls access to memory 102 by other components of computer system 100.

Peripherals interface 118 can be used to couple input and output peripherals of the computer system to CPU 120 and memory 102. The one or more processors 120 run or execute various software programs and/or sets of instructions stored in memory 102 to perform various functions for computer system 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications computer systems via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other computer systems by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

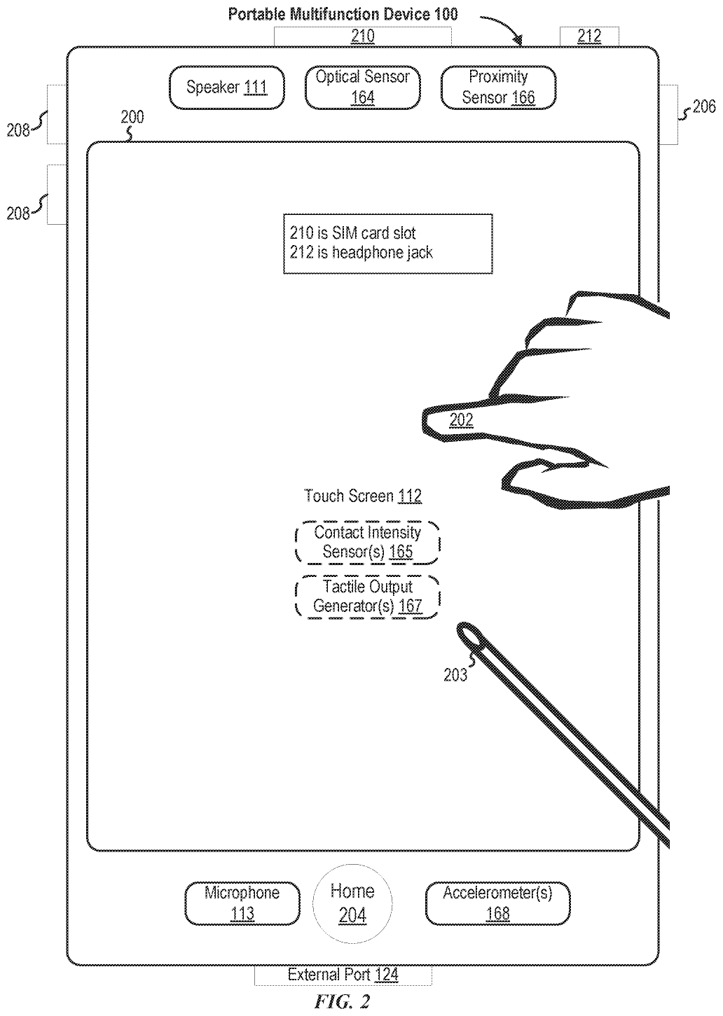

Audio circuitry 110, speaker 111, and microphone 113 provide an audio interface between a user and computer system 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on computer system 100, such as touch screen 112 and other input control computer systems 116, to peripherals interface 118. I/O subsystem 106 optionally includes display controller 156, optical sensor controller 158, intensity sensor controller 159, haptic feedback controller 161, and one or more input controllers 160 for other input or control computer systems. The one or more input controllers 160 receive/send electrical signals from/to other input control computer systems 116. The other input control computer systems 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, an infrared port, a USB port, and a pointer computer system such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the computer system, as described in U.S. patent application Ser. No. 11/322,549, “Unlocking a Computer system by Performing Gestures on an Unlock Image,” filed Dec. 23, 2005, U.S. Pat. No. 7,657,849, which is hereby incorporated by reference in its entirety. A longer press of the push button (e.g., 206) optionally turns power to computer system 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the computer system and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from computer system 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input devices,” filed Jul. 30, 2004; (4) U.S. patent application Ser. No. 11/048,264, “Gestures For Touch Sensitive Input devices,” filed Jan. 31, 2005; (5) U.S. patent application Ser. No. 11/038,590, “Mode-Based Graphical User Interfaces For Touch Sensitive Input devices,” filed Jan. 18, 2005; (6) U.S. patent application Ser. No. 11/228,758, “Virtual Input device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Computer system,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the computer system translates the rough finger-based input into a precise pointer/cursor position or command for performing the actions desired by the user.

In some embodiments, in addition to the touch screen, computer system 100 optionally includes a touchpad (not shown) for activating or deactivating particular functions. In some embodiments, the touchpad is a touch-sensitive area of the computer system that, unlike the touch screen, does not display visual output. The touchpad is, optionally, a touch-sensitive surface that is separate from touch screen 112 or an extension of the touch-sensitive surface formed by the touch screen.

Computer system 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable computer systems.

Computer system 100 optionally also includes one or more optical sensors 164. FIG. 1A shows an optical sensor coupled to optical sensor controller 158 in I/O subsystem 106. Optical sensor 164 optionally includes charge-coupled computer system (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of computer system 100, opposite touch screen display 112 on the front of the computer system so that the touch screen display is enabled for use as a viewfinder for still and/or video image acquisition. In some embodiments, an optical sensor is located on the front of the computer system so that the user's image is, optionally, obtained for video conferencing while the user views the other video conference participants on the touch screen display. In some embodiments, the position of optical sensor 164 can be changed by the user (e.g., by rotating the lens and the sensor in the computer system housing) so that a single optical sensor 164 is used along with the touch screen display for both video conferencing and still and/or video image acquisition.

Computer system 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of computer system 100, opposite touch screen display 112, which is located on the front of computer system 100.

Computer system 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Computer system”; Ser. No. 11/240,788, “Proximity Detector In Handheld Computer system”; Ser. No. 11/620,702, “Using Ambient Light Sensor To Augment Proximity Sensor Output”; Ser. No. 11/586,862, “Automated Response To And Sensing Of User Activity In Portable Computer systems”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction computer system is placed near the user's ear (e.g., when the user is making a phone call).

Computer system 100 optionally also includes one or more tactile output generators 167. FIG. 1A shows a tactile output generator coupled to haptic feedback controller 161 in I/O subsystem 106. Tactile output generator 167 optionally includes one or more electroacoustic computer systems such as speakers or other audio components and/or electromechanical computer systems that convert energy into linear motion such as a motor, solenoid, electroactive polymer, piezoelectric actuator, electrostatic actuator, or other tactile output generating component (e.g., a component that converts electrical signals into tactile outputs on the computer system). Contact intensity sensor 165 receives tactile feedback generation instructions from haptic feedback module 133 and generates tactile outputs on computer system 100 that are capable of being sensed by a user of computer system 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of computer system 100) or laterally (e.g., back and forth in the same plane as a surface of computer system 100). In some embodiments, at least one tactile output generator sensor is located on the back of computer system 100, opposite touch screen display 112, which is located on the front of computer system 100.

Computer system 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Computer systems,” and U.S. Patent Publication No. 20060017692, “Methods And Apparatuses For Operating A Portable Computer system Based On An Accelerometer,” both of which are incorporated by reference herein in their entirety. In some embodiments, information is displayed on the touch screen display in a portrait view or a landscape view based on an analysis of data received from the one or more accelerometers. Computer system 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of computer system 100.

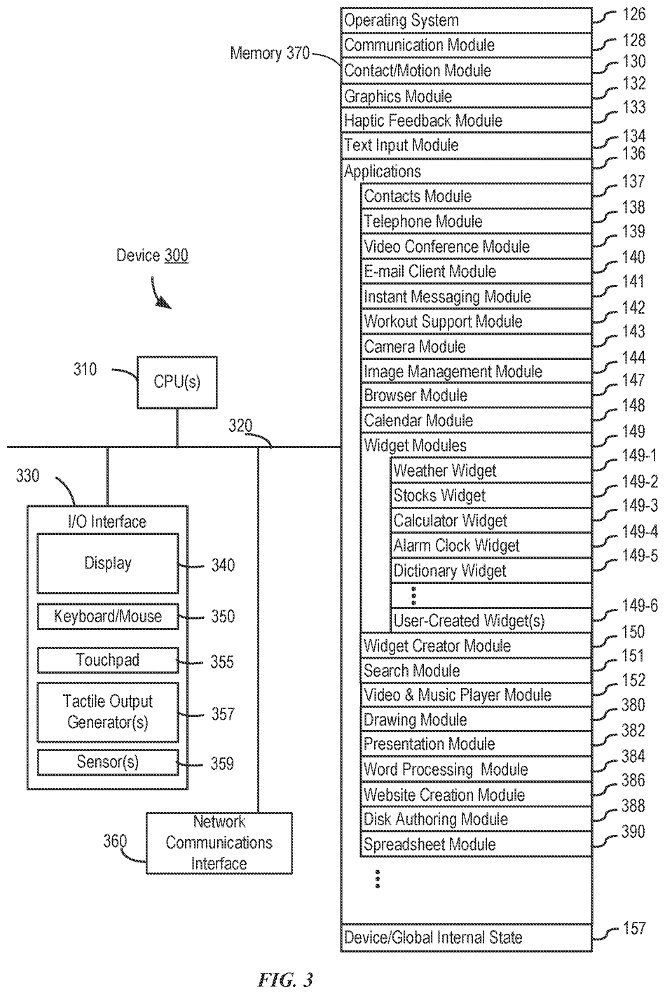

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores computer system/global internal state 157, as shown in FIGS. 1A and 3. Computer system/global internal state 157 includes one or more of: active application state, indicating which applications, if any, are currently active; display state, indicating what applications, views or other information occupy various regions of touch screen display 112; sensor state, including information obtained from the computer system's various sensors and input control computer systems 116; and location information concerning the computer system's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage computer system control, power management, etc.) and facilitates communication between various hardware and software components.

Communication module 128 facilitates communication with other computer systems over one or more external ports 124 and also includes various software components for handling data received by RF circuitry 108 and/or external port 124. External port 124 (e.g., Universal Serial Bus (USB), FIREWIRE, etc.) is adapted for coupling directly to other computer systems or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) computer systems.

Contact/motion module 130 optionally detects contact with touch screen 112 (in conjunction with display controller 156) and other touch-sensitive computer systems (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of computer system 100). For example, a mouse “click” threshold of a trackpad or touch screen display can be set to any of a large range of predefined threshold values without changing the trackpad or touch screen display hardware. Additionally, in some implementations, a user of the computer system is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on computer system 100 in response to user interactions with computer system 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the computer system and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports computer systems); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, computer system 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Computer system, Method, and Graphical User Interface for Playing Online Videos,” filed Jun. 20, 2007, and U.S. patent application Ser. No. 11/968,067, “Portable Multifunction Computer system, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, computer system 100 is a computer system where operation of a predefined set of functions on the computer system is performed exclusively through a touch screen and/or a touchpad. By using a touch screen and/or a touchpad as the primary input control computer system for operation of computer system 100, the number of physical input control computer systems (such as push buttons, dials, and the like) on computer system 100 is, optionally, reduced.

The predefined set of functions that are performed exclusively through a touch screen and/or a touchpad optionally include navigation between user interfaces. In some embodiments, the touchpad, when touched by the user, navigates computer system 100 to a main, home, or root menu from any user interface that is displayed on computer system 100. In such embodiments, a “menu button” is implemented using a touchpad. In some other embodiments, the menu button is a physical push button or other physical input control computer system instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, computer system/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the computer system from one orientation to another (e.g., from a portrait orientation to a landscape orientation, or vice versa), and the event information includes corresponding information about the current orientation (also called computer system attitude) of the computer system.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction computer systems 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the computer system; oral instructions; detected eye movements; biometric inputs; and/or any combination thereof are optionally utilized as inputs corresponding to sub-events which define an event to be recognized.

FIG. 2 illustrates a portable multifunction computer system 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with computer system 100. In some implementations or circumstances, inadvertent contact with a graphic does not select the graphic. For example, a swipe gesture that sweeps over an application icon optionally does not select the corresponding application when the gesture corresponding to selection is a tap.

Computer system 100 optionally also include one or more physical buttons, such as “home” or menu button 204. As described previously, menu button 204 is, optionally, used to navigate to any application 136 in a set of applications that are, optionally, executed on computer system 100. Alternatively, in some embodiments, the menu button is implemented as a soft key in a GUI displayed on touch screen 112.

In some embodiments, computer system 100 includes touch screen 112, menu button 204, push button 206 for powering the computer system on/off and locking the computer system, volume adjustment button(s) 208, subscriber identity module (SIM) card slot 210, headset jack 212, and docking/charging external port 124. Push button 206 is, optionally, used to turn the power on/off on the computer system by depressing the button and holding the button in the depressed state for a predefined time interval; to lock the computer system by depressing the button and releasing the button before the predefined time interval has elapsed; and/or to unlock the computer system or initiate an unlock process. In an alternative embodiment, computer system 100 also accepts verbal input for activation or deactivation of some functions through microphone 113. Computer system 100 also, optionally, includes one or more contact intensity sensors 165 for detecting intensity of contacts on touch screen 112 and/or one or more tactile output generators 167 for generating tactile outputs for a user of computer system 100.

FIG. 3 is a block diagram of an exemplary multifunction computer system with a display and a touch-sensitive surface in accordance with some embodiments. Computer system 300 need not be portable. In some embodiments, computer system 300 is a laptop computer, a desktop computer, a tablet computer, a multimedia player computer system, a navigation computer system, an educational computer system (such as a child's learning toy), a gaming system, or a control computer system (e.g., a home or industrial controller). Computer system 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Computer system 300 includes input/output (I/O) interface 330 comprising display 340, which is typically a touch screen display. I/O interface 330 also optionally includes a keyboard and/or mouse (or other pointing computer system) 350 and touchpad 355, tactile output generator 357 for generating tactile outputs on computer system 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory computer systems; and optionally includes non-volatile memory, such as one or more magnetic disk storage computer systems, optical disk storage computer systems, flash memory computer systems, or other non-volatile solid state storage computer systems. Memory 370 optionally includes one or more storage computer systems remotely located from CPU(s) 310. In some embodiments, memory 370 stores programs, modules, and data structures analogous to the programs, modules, and data structures stored in memory 102 of portable multifunction computer system 100 (FIG. 1A), or a subset thereof. Furthermore, memory 370 optionally stores additional programs, modules, and data structures not present in memory 102 of portable multifunction computer system 100. For example, memory 370 of computer system 300 optionally stores drawing module 380, presentation module 382, word processing module 384, website creation module 386, disk authoring module 388, and/or spreadsheet module 390, while memory 102 of portable multifunction computer system 100 (FIG. 1A) optionally does not store these modules.

Each of the above-identified elements in FIG. 3 is, optionally, stored in one or more of the previously mentioned memory computer systems. Each of the above-identified modules corresponds to a set of instructions for performing a function described above. The above-identified modules or programs (e.g., sets of instructions) need not be implemented as separate software programs, procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction computer system 100.

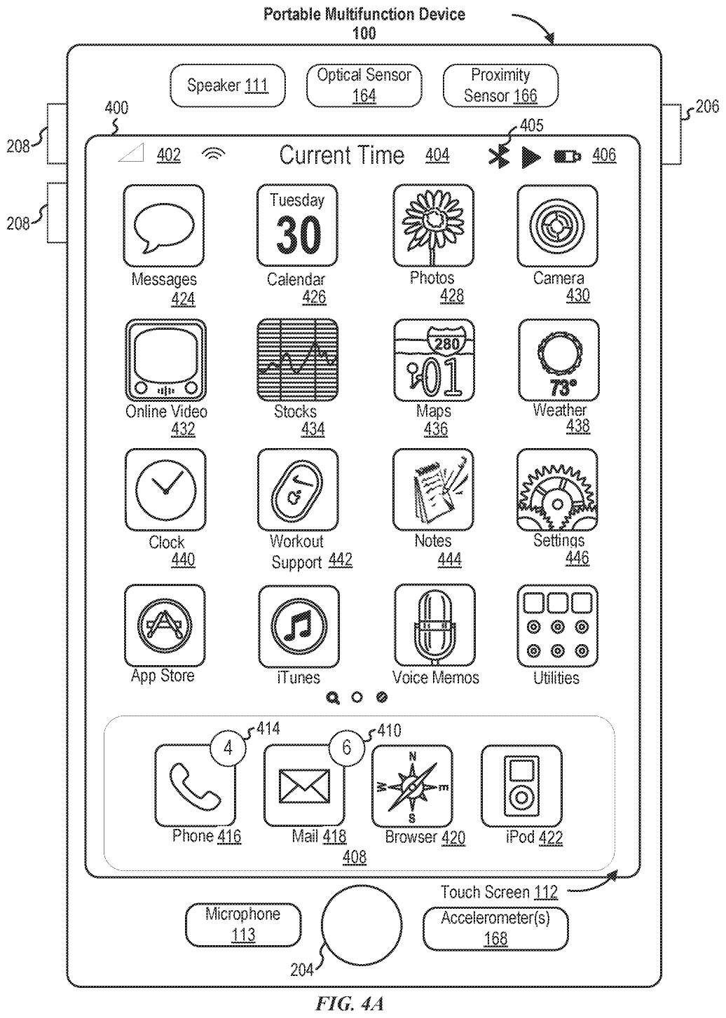

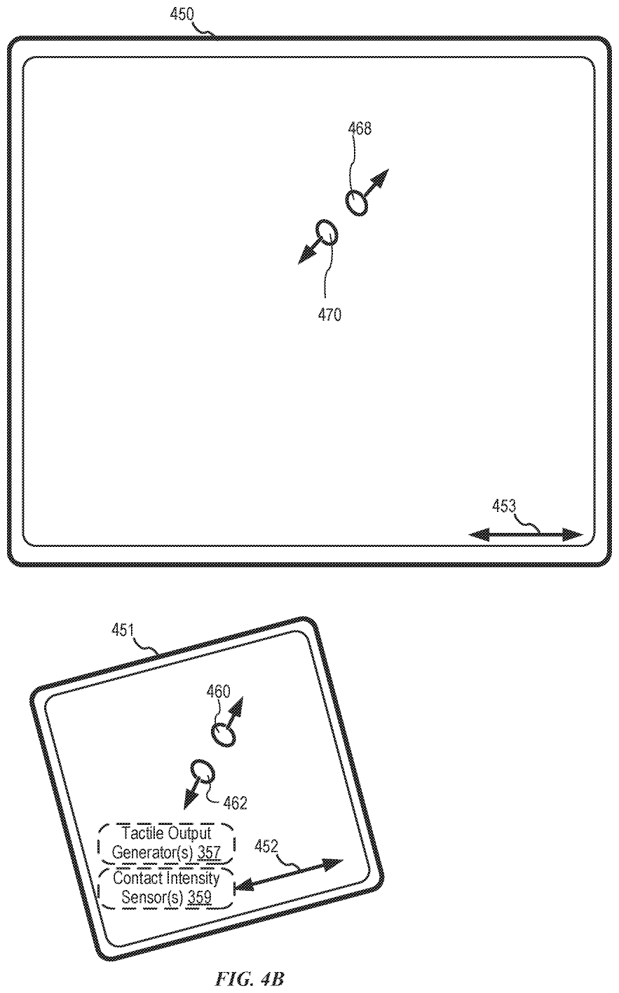

FIG. 4A illustrates an exemplary user interface for a menu of applications on portable multifunction computer system 100 in accordance with some embodiments. Similar user interfaces are, optionally, implemented on computer system 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for computer system 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a computer system (e.g., computer system 300, FIG. 3) with a touch-sensitive surface 451 (e.g., a tablet or touchpad 355, FIG. 3) that is separate from the display 450 (e.g., touch screen display 112). Computer system 300 also, optionally, includes one or more contact intensity sensors (e.g., one or more of sensors 359) for detecting intensity of contacts on touch-sensitive surface 451 and/or one or more tactile output generators 357 for generating tactile outputs for a user of computer system 300.

Although some of the examples that follow will be given with reference to inputs on touch screen display 112 (where the touch-sensitive surface and the display are combined), in some embodiments, the computer system detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the computer system detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the computer system on the touch-sensitive surface (e.g., 451 in FIG. 4B) are used by the computer system to manipulate the user interface on the display (e.g., 450 in FIG. 4B) of the multifunction computer system when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

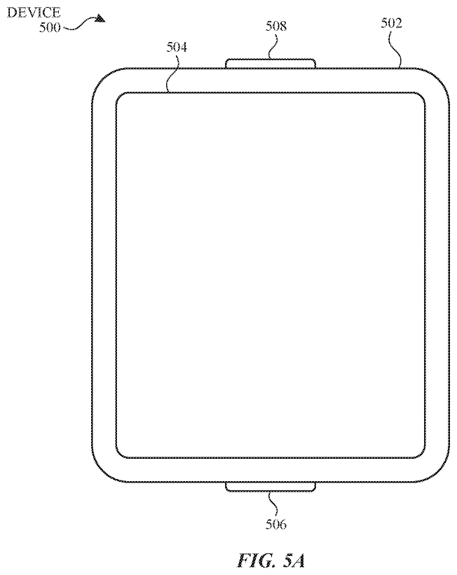

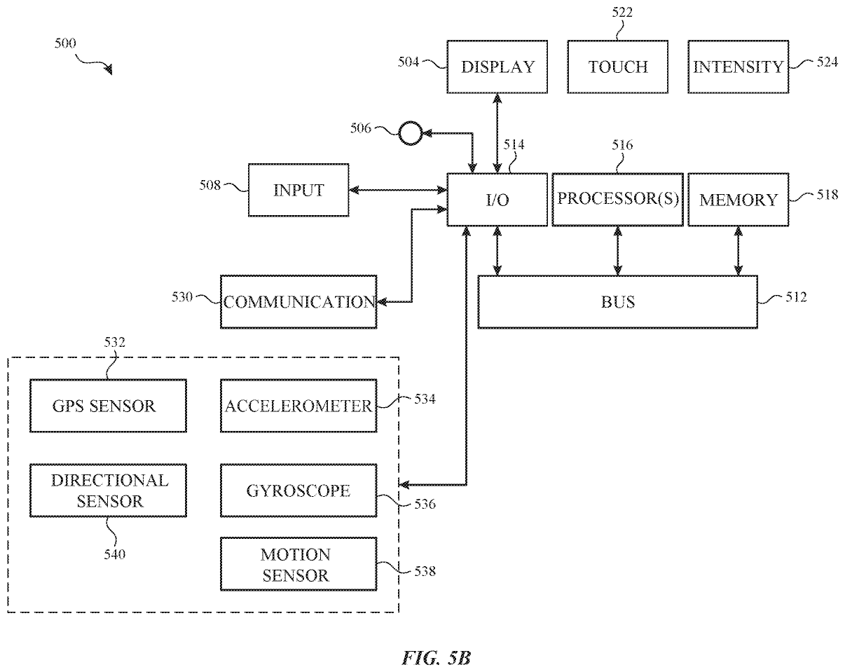

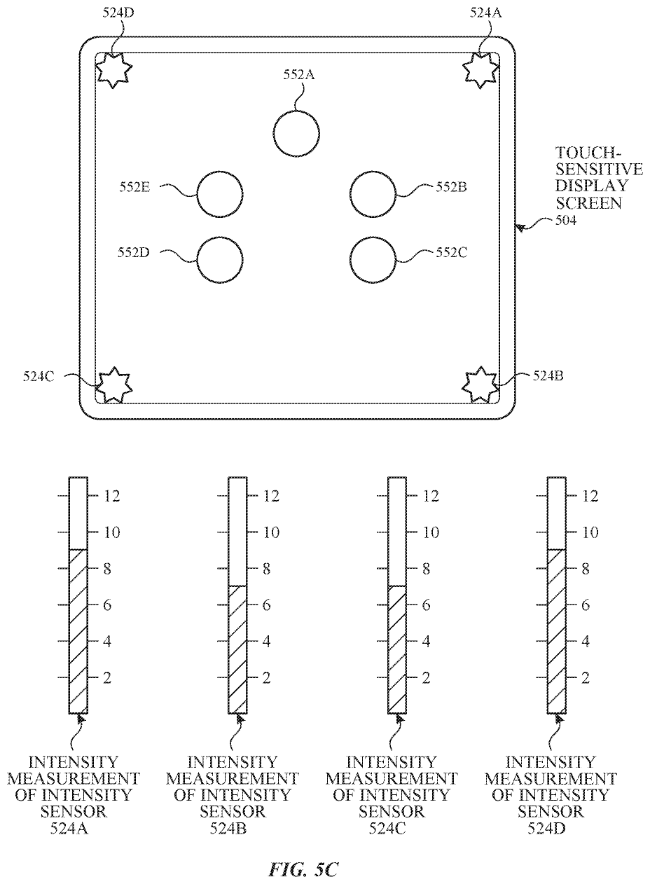

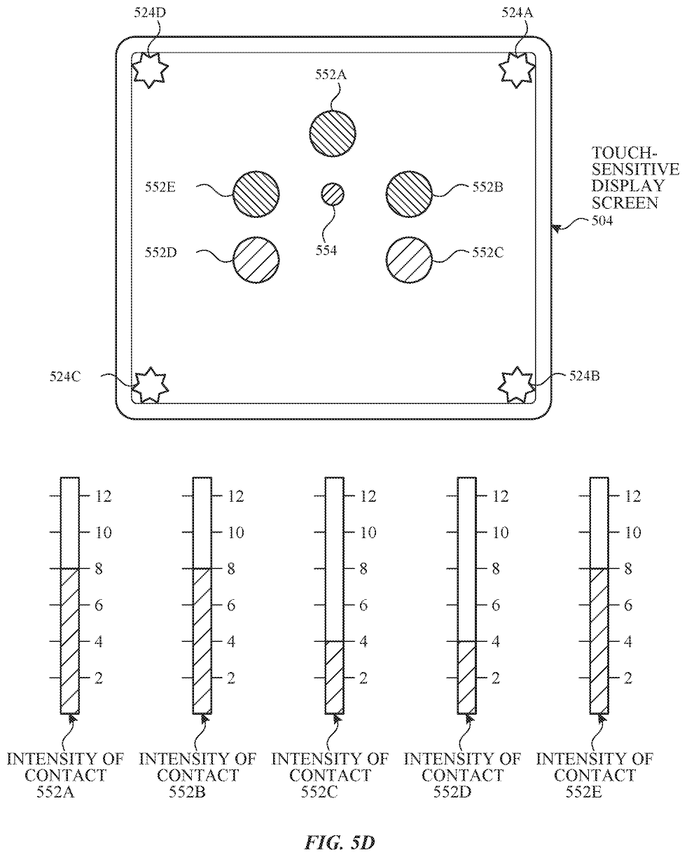

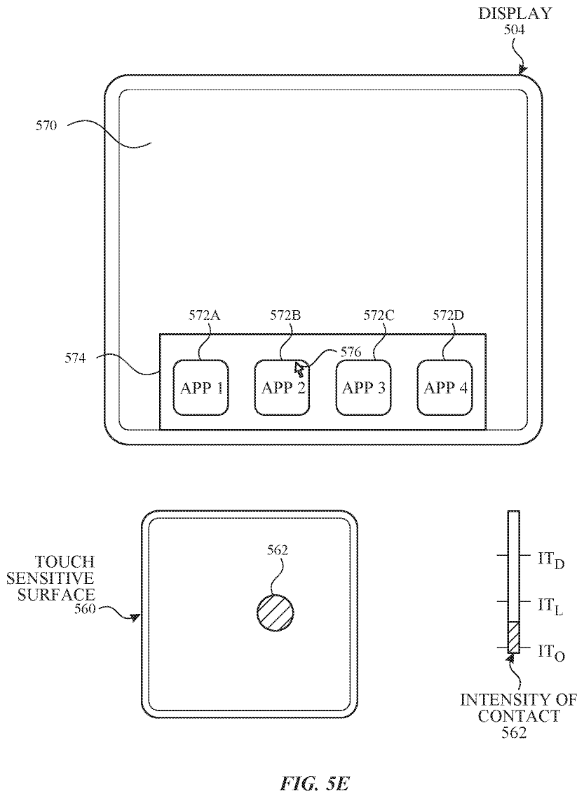

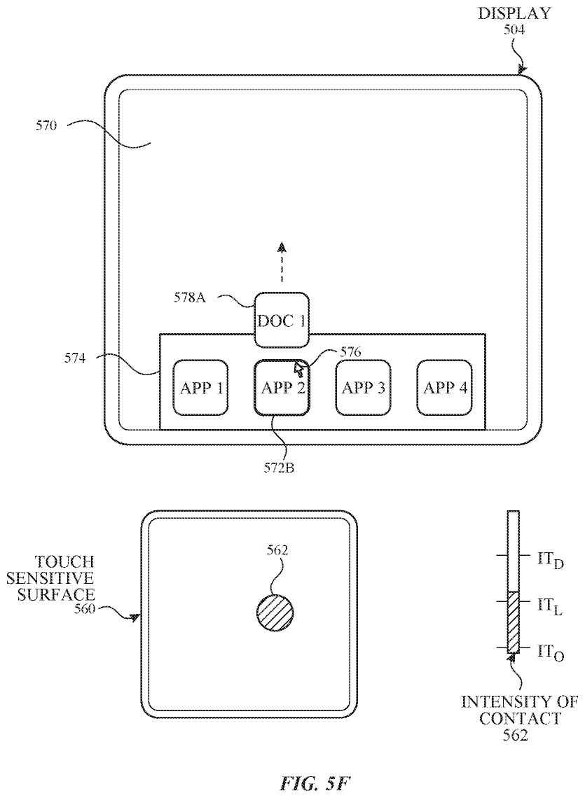

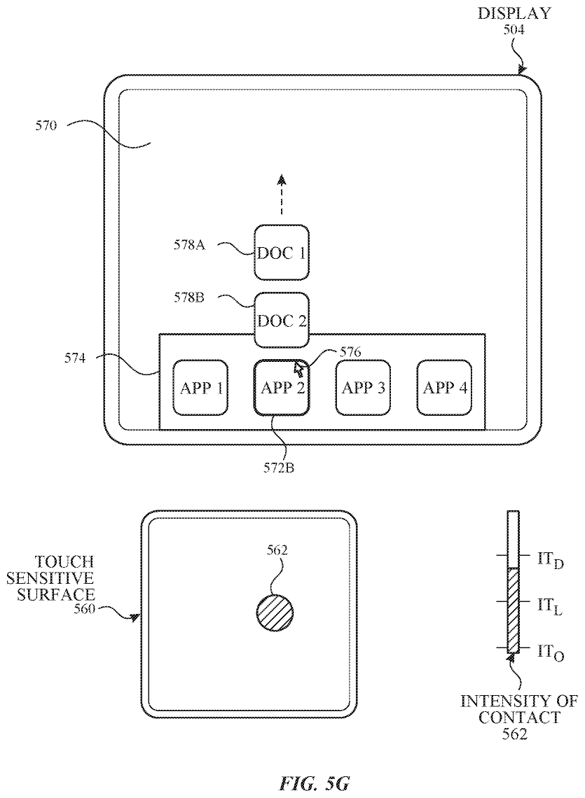

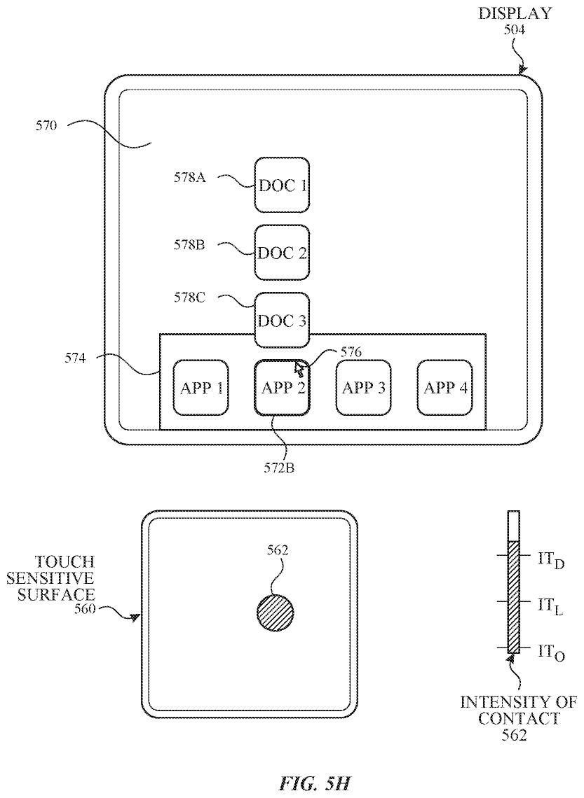

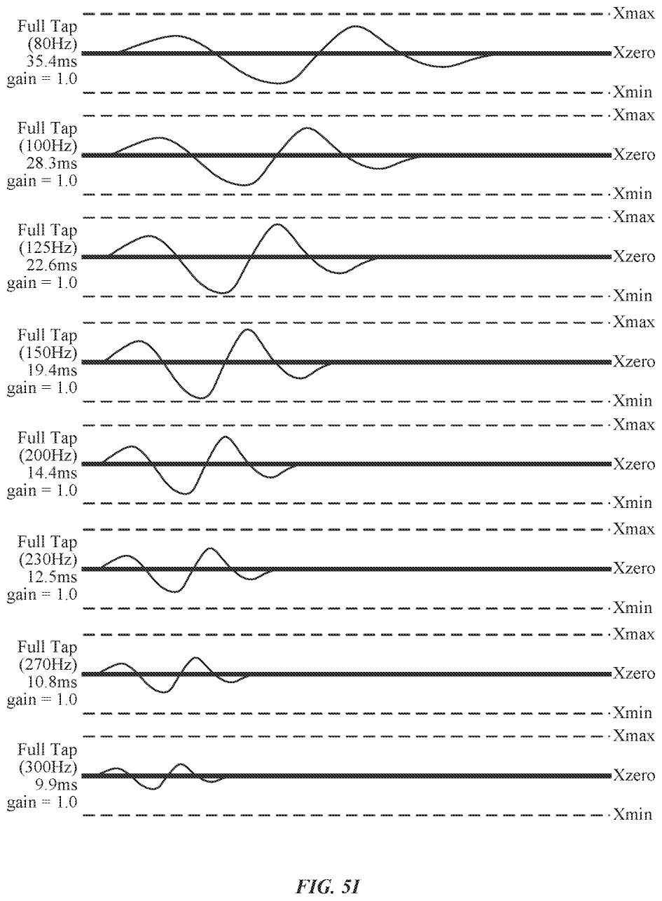

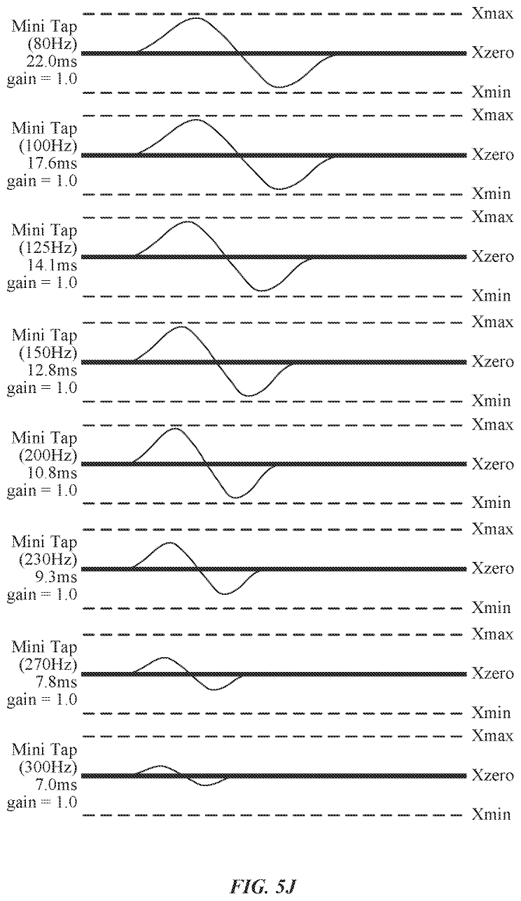

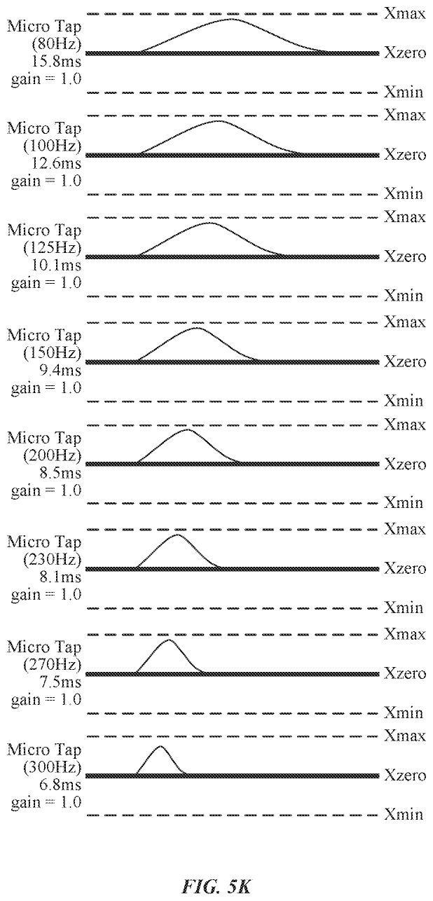

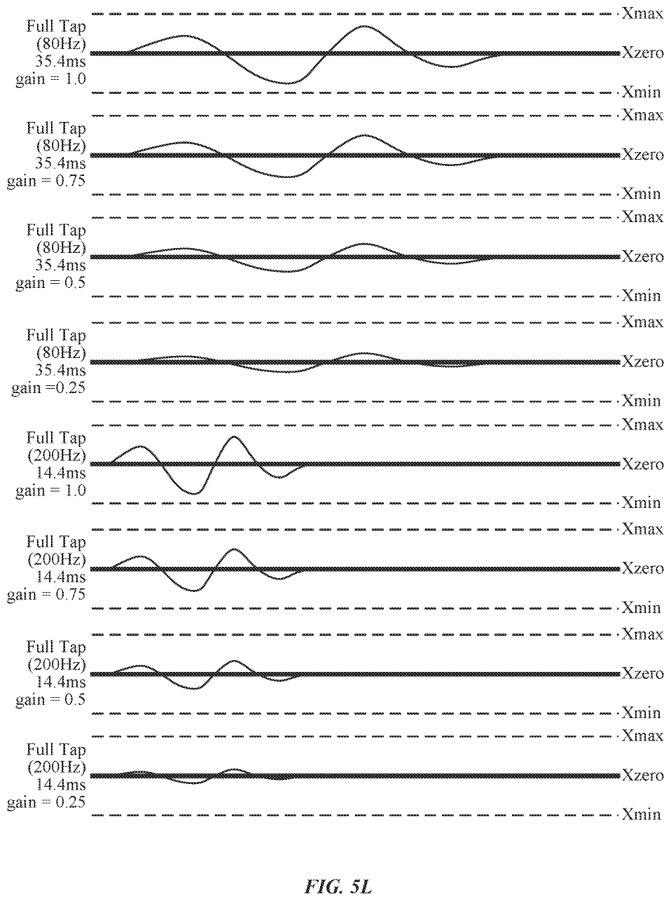

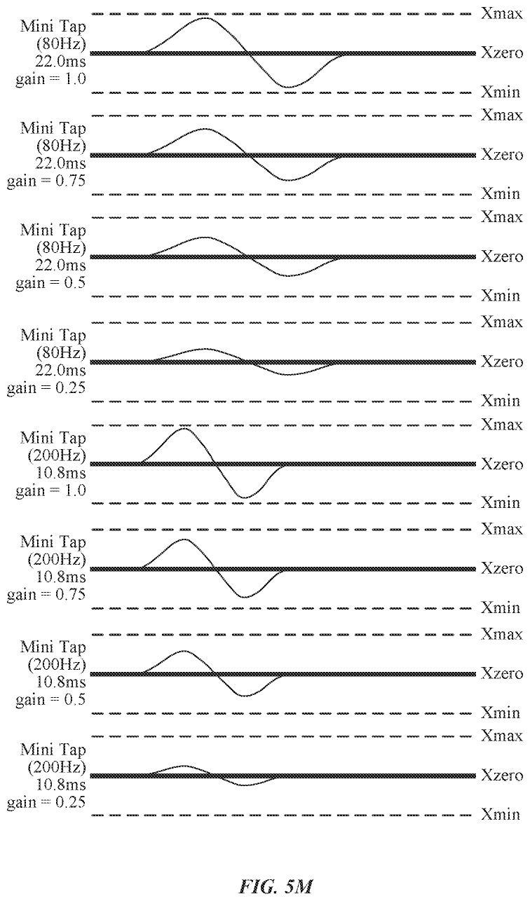

FIG. 5A illustrates exemplary personal computer system 500. Computer system 500 includes body 502. In some embodiments, computer system 500 can include some or all of the features described with respect to computer systems 100 and 300 (e.g., FIGS. 1A-4B). In some embodiments, computer system 500 has touch-sensitive display screen 504, hereafter touch screen 504. Alternatively, or in addition to touch screen 504, computer system 500 has a display and a touch-sensitive surface. As with computer systems 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of computer system 500 can respond to touches based on their intensity, meaning that touches of different intensities can invoke different user interface operations on computer system 500.

Exemplary techniques for detecting and processing touch intensity are found, for example, in related applications: International Patent Application Serial No. PCT/US2013/040061, titled “Computer system, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Computer system, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, computer system 500 has one or more input mechanisms 506 and 508. Input mechanisms 506 and 508, if included, can be physical. Examples of physical input mechanisms include push buttons and rotatable mechanisms. In some embodiments, computer system 500 has one or more attachment mechanisms. Such attachment mechanisms, if included, can permit attachment of computer system 500 with, for example, hats, eyewear, earrings, necklaces, shirts, jackets, bracelets, watch straps, chains, trousers, belts, shoes, purses, backpacks, and so forth. These attachment mechanisms permit computer system 500 to be worn by a user.

FIG. 5B depicts exemplary personal computer system 500. In some embodiments, computer system 500 can include some or all of the components described with respect to FIGS. 1A, 1B, and 3. Computer system 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Computer system 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal computer system 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

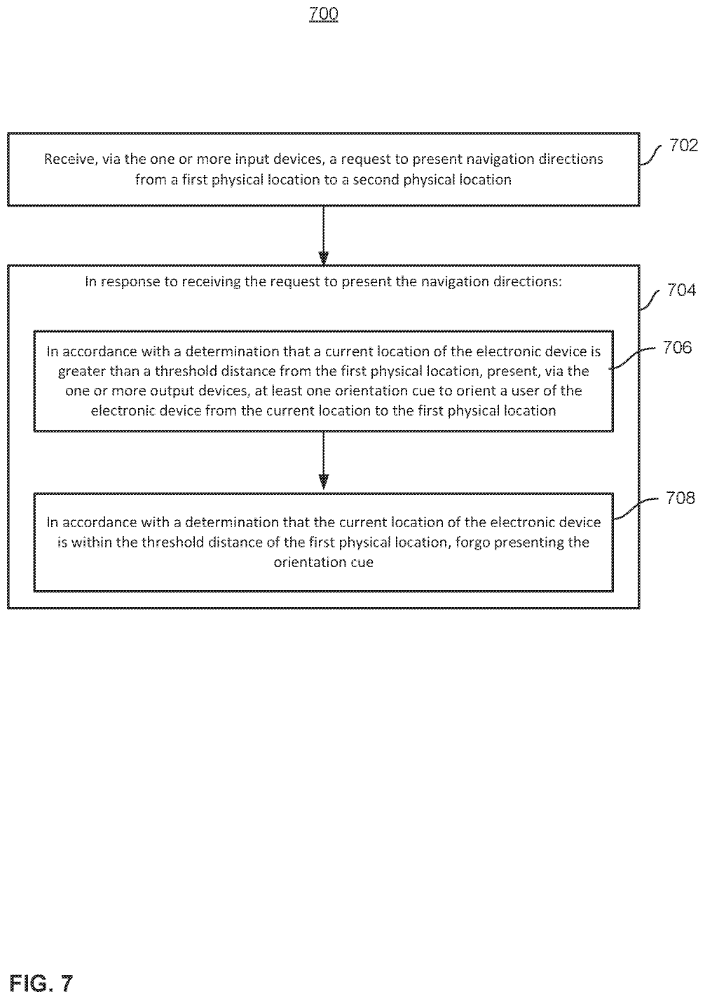

Memory 518 of personal computer system 500 can include one or more non-transitory computer-readable storage mediums, for storing computer-executable instructions, which, when executed by one or more computer processors 516, for example, can cause the computer processors to perform the techniques described below, including process 700 (FIG. 7). A computer-readable storage medium can be any medium that can tangibly contain or store computer-executable instructions for use by or in connection with the instruction execution system, apparatus, or computer system. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal computer system 500 is not limited to the components and configuration of FIG. 5B, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of computer systems 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the computer system, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the computer system).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using a computer system similar or identical to computer system 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the computer system will perform operations typically associated with clicking a button of a physical mouse or a trackpad. In some embodiments, the deep press intensity threshold corresponds to an intensity at which the computer system will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the computer system will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “ITL”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The computer system determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using a computer system similar or identical to computer system 100, 300, or 500.

In some embodiments, the computer system employs intensity hysteresis to avoid accidental inputs sometimes termed “jitter,” where the computer system defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the computer system detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

In some embodiments, computer system 500 includes one or more tactile output generators, where the one or more tactile output generators generate different types of tactile output sequences, as described below in Table 1. In some embodiments, a particular type of tactile output sequence generated by the one or more tactile output generators of the computer system corresponds to a particular tactile output pattern. For example, a tactile output pattern specifies characteristics of a tactile output, such as the amplitude of the tactile output, the shape of a movement waveform of the tactile output, the frequency of the tactile output, and/or the duration of the tactile output. When tactile outputs with different tactile output patterns are generated by a computer system (e.g., via one or more tactile output generators that move a moveable mass to generate tactile outputs), the tactile outputs may invoke different haptic sensations in a user holding or touching the computer system. While the sensation of the user is based on the user's perception of the tactile output, most users will be able to identify changes in waveform, frequency, and amplitude of tactile outputs generated by the computer system.

More specifically, FIGS. 5I-5K provide a set of sample tactile output patterns that may be used, either individually or in combination, either as is or through one or more transformations (e.g., modulation, amplification, truncation, etc.), to create suitable haptic feedback in various scenarios and for various purposes, such as those mentioned above and those described with respect to the user interfaces and methods discussed herein. This example of a palette of tactile outputs shows how a set of three waveforms and eight frequencies can be used to produce an array of tactile output patterns. In addition to the tactile output patterns shown in these figures, each of these tactile output patterns is optionally adjusted in amplitude by changing a gain value for the tactile output pattern, as shown, for example for FullTap 80 Hz, FullTap 200 Hz, MiniTap 80 Hz, MiniTap 200 Hz, MicroTap 80 Hz, and MicroTap 200 Hz in FIGS. 5L-5N, which are each shown with variants having a gain of 1.0, 0.75, 0.5, and 0.25. As shown in FIGS. 5L-5N, changing the gain of a tactile output pattern changes the amplitude of the pattern without changing the frequency of the pattern or changing the shape of the waveform. In some embodiments, changing the frequency of a tactile output pattern also results in a lower amplitude as some tactile output generators are limited by how much force can be applied to the moveable mass and thus higher frequency movements of the mass are constrained to lower amplitudes to ensure that the acceleration needed to create the waveform does not require force outside of an operational force range of the tactile output generator (e.g., the peak amplitudes of the FullTap at 230 Hz, 270 Hz, and 300 Hz are lower than the amplitudes of the FullTap at 80 Hz, 100 Hz, 125 Nz, and 200 Hz).

FIGS. 5I-5N show tactile output patterns that have a particular waveform. The waveform of a tactile output pattern represents the pattern of physical displacements relative to a neutral position (e.g., Xzero) versus time that a moveable mass goes through to generate a tactile output with that tactile output pattern. For example, a first set of tactile output patterns shown in FIG. 5I (e.g., tactile output patterns of a “FullTap”) each have a waveform that includes an oscillation with two complete cycles (e.g., an oscillation that starts and ends in a neutral position and crosses the neutral position three times). A second set of tactile output patterns shown in FIG. 5J (e.g., tactile output patterns of a “MiniTap”) each have a waveform that includes an oscillation that includes one complete cycle (e.g., an oscillation that starts and ends in a neutral position and crosses the neutral position one time). A third set of tactile output patterns shown in FIG. 5K (e.g., tactile output patterns of a “MicroTap”) each have a waveform that includes an oscillation that include one half of a complete cycle (e.g., an oscillation that starts and ends in a neutral position and does not cross the neutral position). The waveform of a tactile output pattern also includes a start buffer and an end buffer that represent the gradual speeding up and slowing down of the moveable mass at the start and at the end of the tactile output. The example waveforms shown in FIGS. 5I-5N include Xmin and Xmax values which represent the maximum and minimum extent of movement of the moveable mass. For larger computer systems with larger moveable masses, there may be larger or smaller minimum and maximum extents of movement of the mass. The examples shown in FIGS. 5I-5N describe movement of a mass in one dimension, however similar principles would also apply to movement of a moveable mass in two or three dimensions.

As shown in FIGS. 5I-5K, each tactile output pattern also has a corresponding characteristic frequency that affects the “pitch” of a haptic sensation that is felt by a user from a tactile output with that characteristic frequency. For a continuous tactile output, the characteristic frequency represents the number of cycles that are completed within a given period of time (e.g., cycles per second) by the moveable mass of the tactile output generator. For a discrete tactile output, a discrete output signal (e.g., with 0.5, 1, or 2 cycles) is generated, and the characteristic frequency value specifies how fast the moveable mass needs to move to generate a tactile output with that characteristic frequency. As shown in FIGS. 5I-5N, for each type of tactile output (e.g., as defined by a respective waveform, such as FullTap, MiniTap, or MicroTap), a higher frequency value corresponds to faster movement(s) by the moveable mass, and hence, in general, a shorter time to complete the tactile output (e.g., including the time to complete the required number of cycle(s) for the discrete tactile output, plus a start and an end buffer time). For example, a FullTap with a characteristic frequency of 80 Hz takes longer to complete than FullTap with a characteristic frequency of 100 Hz (e.g., 35.4 ms vs. 28.3 ms in FIG. 5I). In addition, for a given frequency, a tactile output with more cycles in its waveform at a respective frequency takes longer to complete than a tactile output with fewer cycles its waveform at the same respective frequency. For example, a FullTap at 150 Hz takes longer to complete than a MiniTap at 150 Hz (e.g., 19.4 ms vs. 12.8 ms), and a MiniTap at 150 Hz takes longer to complete than a MicroTap at 150 Hz (e.g., 12.8 ms vs. 9.4 ms). However, for tactile output patterns with different frequencies this rule may not apply (e.g., tactile outputs with more cycles but a higher frequency may take a shorter amount of time to complete than tactile outputs with fewer cycles but a lower frequency, and vice versa). For example, at 300 Hz, a FullTap takes as long as a MiniTap (e.g., 9.9 ms).

As shown in FIGS. 5I-5K, a tactile output pattern also has a characteristic amplitude that affects the amount of energy that is contained in a tactile signal, or a “strength” of a haptic sensation that may be felt by a user through a tactile output with that characteristic amplitude. In some embodiments, the characteristic amplitude of a tactile output pattern refers to an absolute or normalized value that represents the maximum displacement of the moveable mass from a neutral position when generating the tactile output. In some embodiments, the characteristic amplitude of a tactile output pattern is adjustable, e.g., by a fixed or dynamically determined gain factor (e.g., a value between 0 and 1), in accordance with various conditions (e.g., customized based on user interface contexts and behaviors) and/or preconfigured metrics (e.g., input-based metrics, and/or user-interface-based metrics). In some embodiments, an input-based metric (e.g., an intensity-change metric or an input-speed metric) measures a characteristic of an input (e.g., a rate of change of a characteristic intensity of a contact in a press input or a rate of movement of the contact across a touch-sensitive surface) during the input that triggers generation of a tactile output. In some embodiments, a user-interface-based metric (e.g., a speed-across-boundary metric) measures a characteristic of a user interface element (e.g., a speed of movement of the element across a hidden or visible boundary in a user interface) during the user interface change that triggers generation of the tactile output. In some embodiments, the characteristic amplitude of a tactile output pattern may be modulated by an “envelope” and the peaks of adjacent cycles may have different amplitudes, where one of the waveforms shown above is further modified by multiplication by an envelope parameter that changes over time (e.g., from 0 to 1) to gradually adjust amplitude of portions of the tactile output over time as the tactile output is being generated.

Although specific frequencies, amplitudes, and waveforms are represented in the sample tactile output patterns in FIGS. 5I-5K for illustrative purposes, tactile output patterns with other frequencies, amplitudes, and waveforms may be used for similar purposes. For example, waveforms that have between 0.5 to 4 cycles can be used. Other frequencies in the range of 60 Hz-400 Hz may be used as well. Table 1 below provides representative examples of tactile output/haptic feedback behaviors and configurations, and examples of their use with respect to the user interfaces for managing content-based tactile outputs that are illustrated and described herein.

TABLE 1

| Type of Tactile | | Textural (continuous) |
|---|---|---|
| Output Sequence | Waveform | or Discrete |
| “Major” | MiniTap at 180 Hz | Discrete |
| “Minor” | MicroTap at 80 Hz | Textural |
| “Major-reduced” | MiniTap at 200 Hz | Discrete |
| “Minor-Reduced” | MicroTap at 200 Hz | Discrete |

As used herein, an “installed application” refers to a software application that has been downloaded onto a computer system (e.g., computer systems 100, 300, and/or 500) and is ready to be launched (e.g., become opened) on the computer system. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of computer system/global internal state 157 and/or application internal state 192). An open or executing application is, optionally, any one of the following types of applications:
an active application, which is currently displayed on a display screen of the computer system that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the computer system). Accordingly, closing an application includes stopping and/or removing application processes for the application and removing state information for the application from the memory of the computer system. Generally, opening a second application while in a first application does not close the first application. When the second application is displayed and the first application ceases to be displayed, the first application becomes a background application.

Attention is now directed towards embodiments of user interfaces (“UP”) and associated processes that are implemented on a computer system, such as portable multifunction computer system 100, computer system 300, or computer system 500.

### User Interfaces and Associated Processes

### Localization Feedback

Users interact with computer systems in many different manners. In some embodiments, a computer system presents navigation directions from a first physical location to a second physical location. In some embodiments, the first physical location is different from a current location of the computer system, such as in situations in which the current location of the computer system is a location that is not connected by roads and/or paths included in the map to the roads and/or paths to the second physical location. The embodiments described below provide ways in which a computer system presents feedback indicative of the distance and direction to the starting location of the navigation directions when a feedback mode is active on the computer system. Enhancing interactions with a computer system reduces the amount of time needed by a user to perform operations, and thus reduces the power usage of the computer system and increases battery life for battery-powered computer systems. The ability for a user account to receive indications of distance and/or direction to a physical location is intended to be used by users to understand their physical environment with the assistance of computer systems. It is understood that people use computer systems. When a person uses a computer system, that person is optionally referred to as a user of the computer system.

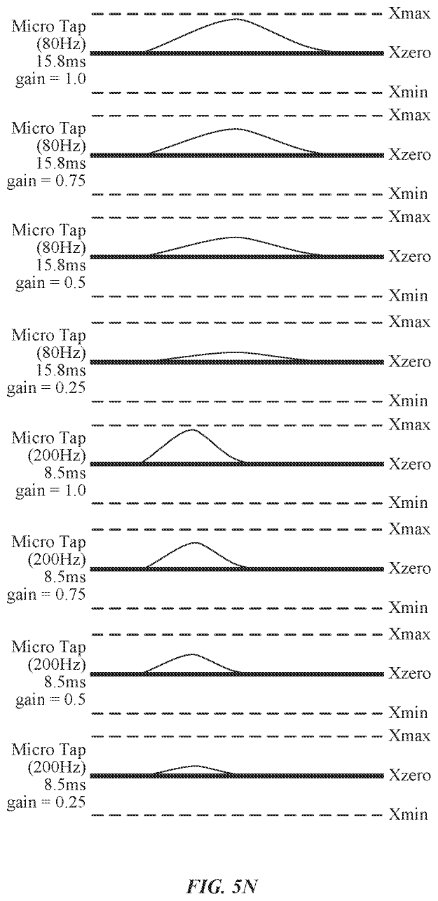

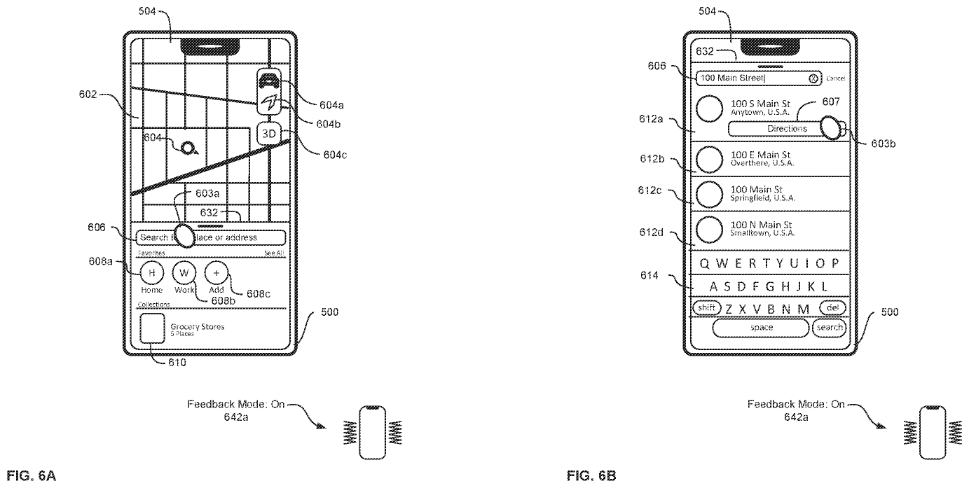

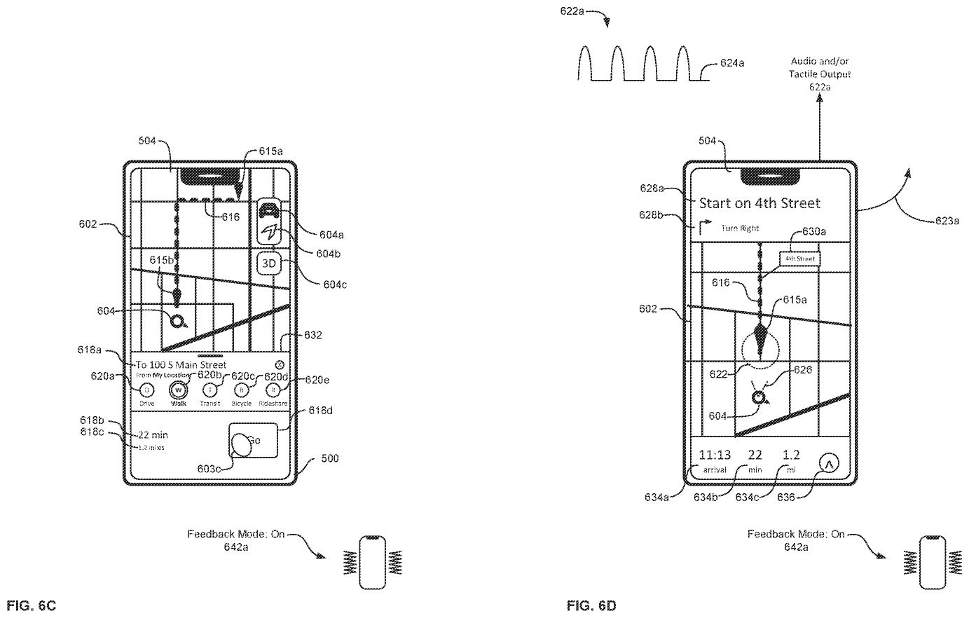

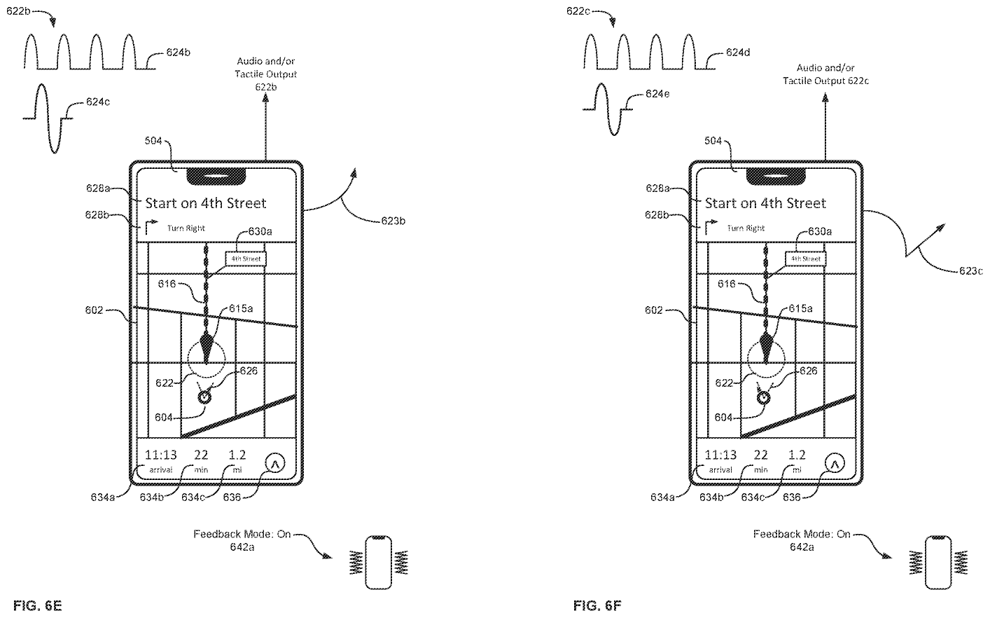

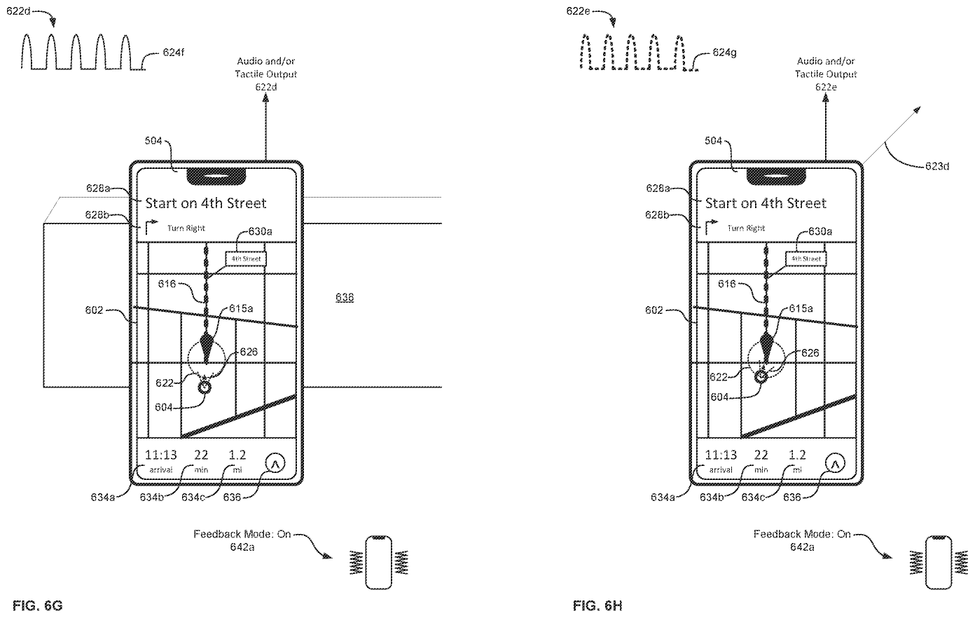

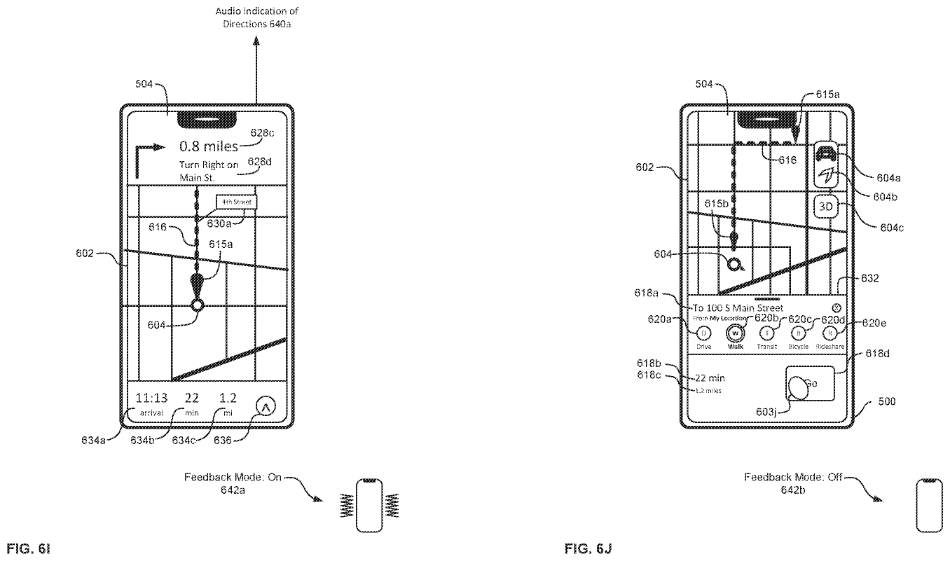

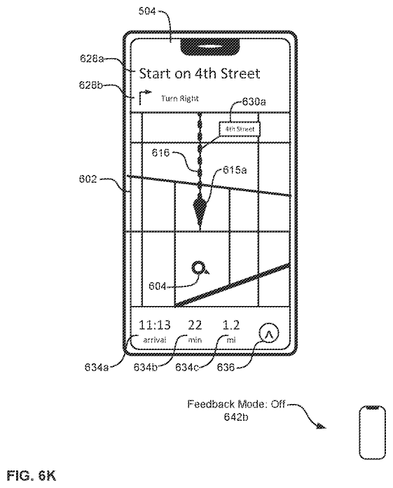

FIGS. 6A-6K illustrate exemplary ways of presenting indications of distance and/or direction to a navigation starting location in accordance with some embodiments of the disclosure. In some embodiments, the techniques illustrated in FIG. 6A-6K are performed at a computer system. The embodiments in these figures are used to illustrate the processes described below, including the processes described with reference to FIG. 7.

FIG. 6A illustrates an example of the computer system 500 presenting a navigation user interface of a map application. For example, the user interface includes a map 602 that includes an indication 604 of the current location of the computer system 500 relative to the map 602. As shown in FIG. 6A, the user interface further includes a selectable option 604a that, when selected, causes the computer system 500 to toggle the type of map being displayed (e.g., driving map, transit map, and/or a satellite map), an option 604b that, when selected, causes the computer system 500 to orient the map 602 with the same orientation as the computer system 500, and an option 604c that, when selected, causes the computer system 500 to display the map 602 in three-dimensions. In some embodiments, the user interface includes a user interface element 632 overlaid on the map 602 that includes a search box 606 for searching for a location and/or address, options 608a and 608b that, when selected, cause the computer system 500 to initiate a process to present navigation directions to stored “favorite” locations, an option 608c that, when selected, causes the computer system 500 to initiate a process to save another location as a “favorite” location, and an option 610 that, when selected, causes the computer system 500 to display a list of locations included in a user-curated collection.

In some embodiments, the computer system 500 displays navigation directions that start at a location that is different from the current location of the computer system 500. In some embodiments, while the computer system 500 presents the user interface in FIG. 6A, the computer system 500 is in a feedback mode of operation in which the computer system 500 is configured to present audio and/or tactile indications of the distance and/or direction to a start location of navigation directions, as indicated by legend 642a in FIG. 6A. FIGS. 6A-6I illustrate examples of the computer system 500 operating with the feedback mode on and FIGS. 6J-6K illustrate examples of the computer system 500 operating with the feedback mode off.

In FIG. 6A, the computer system 500 detects an input (e.g., including contact 603a) corresponding to selection of the search box 606. In some embodiments, in response to detecting selection of the search box 606, the computer system 500 initiates a process to accept text input defining a location and/or address to search for and/or navigate to on the map 602. In response to a sequence of inputs including the input illustrated in FIG. 6A, the computer system 500 displays the user interface illustrated in FIG. 6B.

FIG. 6B illustrates a user interface including search results in response to a sequence of inputs including the input illustrated in FIG. 6A. In some embodiments, the sequence of inputs further includes entry of text into the search box 606 (e.g., “100 Main Street”). For example, the computer system 500 enters the text into the search box 606 in response to detecting one or more inputs directed to soft keyboard 614. The user interface in FIG. 6B further includes indications 612a-612d of search results matching the terms included in the search box 606. In some embodiments, one of the search results 612a is displayed with a selectable option 607 that, when selected, causes the computer system 500 to initiate a process to display navigation directions to the location associated with search result 612a. In some embodiments, two or more of the search results 612a-612d include user-selectable options to get directions similar to option 607.

As shown in FIG. 6B, the computer system 500 detects selection (e.g., via contact 603b) of the option 607 to provide instructions to navigate to the location associated with search result 612a. In some embodiments, in response to the input illustrated in FIG. 6B, the computer system 500 displays the user interface illustrated in FIG. 6C.

FIG. 6C illustrates the computer system 500 displaying a user interface in response to the input illustrated in FIG. 6B. In some embodiments, the user interface includes an indication 616 of a navigation route from a first location indicated by starting indication 615b to a second location indicated by ending indication 615a on the map 602. As shown in FIG. 6C, the current location of the computer system 500, indicated by computer system location indication 604, is different from the location of the start point of the navigation, indicated by starting indication 615b. The user interface is further updated to include options 620a-620e for various means of navigation for which to present directions and an indication 618a of the destination in user interface element 632, for example. In FIG. 6C, the computer system 500 is presenting walking directions, as indicated by the styling of the walk option 620b in user interface element 632, and the user interface element 632 further includes an indication 618b of the estimated duration of the navigation route by walking, an indication 618c of the distance of the navigation route, and a selectable option 618d that, when selected, causes the computer system 500 to initiate navigation directions along the route indicated on the map 602 with indication 616.

As shown in FIG. 6C, the computer system 500 detects selection (e.g., via contact 603c) of the selectable option 618d for beginning the navigation directions. In response to the input illustrated in FIG. 6C, the computer system 500 initiates a process to present the navigation directions, as shown in FIG. 6D.

FIG. 6D illustrates an example of the computer system 500 initiating a process to present the navigation directions in response to the input illustrated in FIG. 6C. In FIG. 6D, the current location of the computer system 500 indicated on the map 602 by indication 604 is more than a threshold distance from the starting location of the navigation directions indicated on the map 602 by starting indication 615a. In some embodiments, the computer system 500 presents a visual indication 628a of the starting location of the navigation directions. Even so, it may be difficult for the user of the computer system 500 to navigate to the starting point of a route as indicated by starting indication 615a. In some implementations, the computer system has an optional orientation mode (e.g., feedback mode) that provides feedback (or other instructions) for the user to orient and navigate to the route starting point. For example, the feedback mode includes audio and/or tactile pulses that indicate the relative distance between the computer system and the starting location of the navigation route and/or the bearing of the computer system relative to the starting location of the navigation route, as described herein with reference to FIGS. 6A-7. In some implementations, the user can set a setting on the computer system 500 to activate (or deactivate) the orientation mode. While in orientation mode, if the user computer system is not located at the starting point of a route, the computer system will provide cues (e.g., visual, audio, and haptic cues) in order to orient and direct the user to the starting point. Although the figures depict obtaining navigational directions and orientation cues/guidance on a single computer system, in some implementations, navigational directions may first be obtained on a computer system (e.g., a different computer system than computer system 500) and then the directions may be pushed to a second computer system, e.g., the computer system 500, before orientation guidance begins. In some embodiments, while the feedback mode is active on the computer system 500, as indicated by legend 642a in FIG. 6D, the computer system 500 presents an audio and/or tactile output 622a including pulses 624a that indicate the distance between the current location of the computer system 500 and the starting point of the navigation directions. In some embodiments, the pulses 624a include audio pulses, such as beeps, dings, and/or tones. In some embodiments, the pulses 624a include tactile pulses, such as one or more of the tactile output patterns described above with reference to FIGS. 5I-5N. In some embodiments, the period between the pulses 624a corresponds to the distance between the current location of the computer system 500 and the starting point of the navigation directions. For example, as the computer system 500 moves closer to the starting point of the navigation directions, the period between the pulses 624a gets shorter.

FIG. 6D includes an indication 622a of a threshold distance of the computer system from the starting point at which characteristics of the pulses 624a change (e.g., the tone of the pulses 624a changes), as described in more detail below with reference to FIG. 6H, and an indication 626 of a range of angles within a margin of error of a direction facing the starting point of the navigation directions, as described in more detail below with reference to FIGS. 6E and 6F. FIG. 6D includes indications 626 and 622 for illustrative purposes; in some embodiments, the computer system 500 does not display indications 626 and 622.

In some embodiments, the user interface further includes an indication 628b of the navigational direction to be performed after the computer system 500 has reached the starting point of the navigation instructions previously determined by the map application, an indication 630a of a name of a street included in the navigation route 616 on the map 602, an indication 634a of an estimated time of arrival at the navigation destination, an indication 634b of an estimated remaining travel time on the navigation route to the navigation destination, an indication 634c of distance remaining along the navigation route, and a selectable option 636 that, when selected, causes the computer system 500 to present additional options for the navigation route, such as options to add a stop along the route, options to report an incident along the route, and an option to share the estimated time of arrival at the navigation destination with a user account associated with another user and/or another computer system.

As indicated by indication 604 in FIG. 6D, the current orientation of the computer system 500 is outside of the range of angles 626 facing the navigation starting point. In FIG. 6D, the computer system 500 detects movement 623a of the computer system 500, e.g., the computer system moves to the left. In some embodiments, the movement 623a of the computer system 500 illustrated in FIG. 6D causes the orientation of the computer system 500 to enter the range of angles 626 facing the navigation starting location. In some embodiments, in response to movement of the computer system 500 illustrated in FIG. 6D, the computer system 500 presents updated feedback, as shown in FIG. 6E.

FIG. 6E illustrates an example of the computer system 500 presenting audio and/or tactile feedback 622b that indicates the orientation of the computer system 500 entering the range of angles 626 facing the navigation starting location in response to the movement of the computer system 500 illustrated in FIG. 6D. In some embodiments, the audio and/or tactile feedback 622b continue to include pulses 624b indicative of the distance between the current location of the computer system 500 and the navigation starting location and additionally include a pulse 624c that indicates that the orientation of the computer system 500 corresponds to a boundary of the range of angles 626 that corresponds to the computer system 500 facing the navigation starting point. In some embodiments, an audio pulse 624c has a different timbre, pitch, pattern, or other characteristic from the characteristic of audio pulses 624b indicating the distance between the computer system 500 and the navigation starting point. In some embodiments, a tactile pulse 624c has a different texture, sharpness, pattern, or other characteristic from the characteristic of tactile pulses 624b that indicate the distance between the computer system 500 and the navigation starting location.

As shown in FIG. 6E, the computer system 500 detects further movement 623b to the left that corresponds to movement of the computer system 500 to an orientation at the other boundary of the range of angles 626 corresponding to facing the navigation starting location. In response to the movement of the computer system 500 illustrated in FIG. 6E, the computer system 500 presents the indication illustrated in FIG. 6F.

FIG. 6F illustrates an example of the computer system 500 presenting audio and/or tactile feedback 622c that indicates the orientation of the computer system 500 exiting the angular distance (space formed by the angles) 626 facing the navigation starting point. In some embodiments, the audio and/or tactile feedback 622c continues to include pulses 624d indicative of the distance between the current location of the computer system 500 and the navigation starting point and additionally includes a pulse 624e that indicates that the orientation of the computer system 500 corresponds to a boundary of the range of angles 626 that corresponds to the computer system 500 facing the direction of the navigation starting point. In some embodiments, an audio pulse 624e has a different timbre, pitch, pattern, or other characteristic from the characteristic of audio pulses 624d indicating the distance between the computer system 500 and the navigation starting location. In some embodiments, a tactile pulse 624e has a different texture, sharpness, pattern, or other characteristic from the characteristic of tactile pulses 624d that indicate the distance between the computer system 500 and the navigation starting point. In some embodiments, the pulse 624e that indicates that the computer system 500 is exiting the space between the range of angles 626 corresponding to the computer system 500 facing the navigation starting location has a smaller magnitude than the pulse 624c in FIG. 6E that indicates that the computer system 500 is entering the range of angles 626 corresponding to the computer system 500 facing the navigation starting location shown in FIG. 6E.

As shown in FIG. 6F, in some embodiments, the computer system 500 detects movement 623c of the computer system 500 to the right and forward. In some embodiments, in response to the movement of the computer system 500 illustrated in FIG. 6F, the computer system 500 updates the indications of the distance between the computer system 500 and the navigation starting location as shown in FIG. 6G.

FIG. 6G illustrates the computer system 500 presenting updated audio and/or tactile feedback 622d indicating the distance between the current location of the computer system 500 and the navigation starting point in response to the movement of the computer system 500 illustrated in FIG. 6F. As shown in FIG. 6G, the pulses 624f included in feedback 622d have a shorter period between pulses than the period between the pulses 624d in FIG. 6F because the distance between the current location of the computer system 500 and the navigation starting point is less in FIG. 6G than in FIG. 6F. In some embodiments, the pitch and/or tone of audio pulses 624f and/or the texture and/or sharpness of tactile pulses 624f are the same as those for pulses 624d.

As shown in FIG. 6G, when there is an obstacle, such as wall 638, between the computer system 500 and the navigation starting point, the computer system 500 presents orientation output 622d independent of the obstacle. For example, even though a wall 638 is between the computer system 500 and the navigation starting point, when the computer system 500 moves towards the navigation starting point (and also the wall), the computer system 500 provides feedback to the user that the user is getting closer to the navigation starting point even though the computer system 500 may need to move away from the wall (and therefore the navigation starting point) to navigate around the wall and actually get to the navigation starting point. In some embodiments, the computer system 500 does not start the navigation directions from the current location of the computer system 500 because the map does not include details between the current location of the computer system 500 and the navigation route, so the computer system 500 may also not have access to data indicating the existence of wall 638. In some embodiments, if the user moves the computer system 500 around the wall 638 in a manner that causes the computer system 500 to be oriented away from the navigation starting location and/or to be at a further distance from the navigation starting location, the computer system 500 continues presenting feedback of the changes in orientation and/or distance relative to the navigation starting location independent from the location of wall 638 relative to the computer system 500 and/or the navigation starting location.

FIG. 6H illustrates the computer system 500 presenting an updated output 622e indicating the distance between the current location of the computer system 500 and the navigation starting point after the computer system 500 has moved around the wall 638 in FIG. 6H and closer to the navigation starting point. In some embodiments, the current location of the computer system 500 is within the predefined threshold 622 of the navigation starting point in FIG. 6H. Examples of the predefined threshold 622 are included below in the description of method 700. In response to detecting the current location of the computer system 500 within the predefined threshold 622 of the navigation starting location, the computer system 500 presents different feedback/orientation cues than while the computer system 500 was more than the threshold distance 622 away from the starting location. For example, pulses 624g are presented with a different characteristic than pulses 624f in FIG. 6G that were presented while the computer system 500 was more than the threshold distance 622 from the navigation starting location. In some implementations, audio pulses 624g have a different pitch and/or tone than audio pulses 624f. As another example, tactile pulses 624g have a different texture and/or sharpness than tactile pulses 624f. In some embodiments, because the computer system 500 is closer to the navigation starting location in FIG. 6H than is the case in FIG. 6G, the period between pulses 624g in FIG. 6H is shorter than the period between pulses 624f in FIG. 6G.

As shown in FIG. 6H, the computer system 500 detects movement 623d of the computer system 500 to the navigation starting location (e.g., and/or within a second, smaller threshold distance of the navigation starting location). In response to the movement of the computer system 500 to the navigation starting location, the computer system 500 ceases presenting output 622e and begins presenting navigation directions, as shown in FIG. 6I.

FIG. 6I illustrates the computer system 500 presenting navigation directions in response to movement of the computer system 500 to the navigation starting location in FIG. 6H. In some embodiments, because the computer system 500 is at a location along the navigation route in FIG. 6I, the computer system 500 no longer presents orientation cues, feedback, or guidance (e.g., an indication of the distance and/or direction) to the navigation starting location in FIG. 6I. In some embodiments, the computer system 500 presents an audio output 640a indicating the next maneuver included in the navigation directions and updates the user interface to include a visual indication 628c of the next maneuver and a visual indication 628d of the maneuver after the next maneuver in the directions. In some embodiments, as the computer system 500 moves along the navigation route, the computer system 500 presents visual and/or audio indications of the navigation route maneuvers.

As shown in FIGS. 6D-6H, while the current location of computer system 500 is away from the navigation starting location while the computer system 500 is presenting audio and/or tactile outputs indicating the distance and/or direction to the navigation starting location, the computer system 500 maintains display of the visual indication 628a of the navigation starting location, the visual indication 628b of the next maneuver in the navigation directions, and forgoes presenting an audio indication of the next maneuver of the navigation directions. In response to detecting the current location of the computer system 500 at the navigation starting location, the computer system 500 updates the user interface as described above with reference to FIG. 6I.

In some embodiments, the computer system 500 presents orientation cues, feedback, or guidance (e.g., audio and/or tactile indications of the distance and/or direction) to the navigation starting location while the computer system 500 is in the feedback (e.g., orientation) mode indicated by legend 642a in FIGS. 6A-6I. In some embodiments, while the feedback (e.g., orientation) mode is not active on the computer system 500, the computer system 500 forgoes presenting orientation cues, feedback, or guidance (e.g., indications of the distance and/or direction) to the navigation starting location irrespective of the distance between the current location of the computer system 500 and the navigation starting location.

For example, FIG. 6J illustrates the computer system 500 presenting the user interface described above with reference to FIG. 6C while the feedback (e.g., orientation) mode is not active on the computer system 500, as indicated by legend 642b. In some embodiments, the computer system 500 presents the user interface in FIG. 6J in response to the sequence of inputs illustrated in FIGS. 6A-6B. As shown in FIG. 6J, the computer system 500 detects selection (e.g., with contact 603j) of the selectable option 618d for initiating a process to navigate from the navigation starting location to the navigation destination while the location of the computer system 500 is away from the navigation starting location. In some embodiments, in response to the input illustrated in FIG. 6J, the computer system 500 updates the user interface as shown in FIG. 6K.

FIG. 6K illustrates the computer system 500 displaying the navigation user interface in response to the input illustrated in FIG. 6J. In FIG. 6K, the computer system 500 presents a visual indication 628a of the navigation starting location because the current location of the computer system 500 indicated by indication 604 is away from the navigation starting location indicated by indication 615a. Because the feedback (orientation) mode is not active on the computer system 500 in FIG. 6K, the computer system 500 forgoes presenting orientation cues, feedback, or guidance (e.g., audio and/or tactile outputs indicating the distance and/or direction) to the navigation starting location. In some embodiments, in response to detecting movement of the computer system 500 to the navigation starting location, the computer system 500 presents the user interface and audio indication 640a of the navigation directions illustrated in FIG. 6I, except the feedback (orientation) mode remains disabled on the computer system 500.

FIG. 7 is a flow diagram illustrating a method of presenting indications of distance and/or direction to a navigation starting location in accordance with some embodiments of the disclosure, such as in FIGS. 6A-6K. The method 700 is optionally performed at a computer system such as computer system 100, computer system 300, or computer system 500 as described above with reference to FIGS. 1A-1B, 2-3, 4A-4B and 5A-5H. In some embodiments, method 700 is performed at a computer system. Some operations in method 700 are, optionally combined and/or order of some operations is, optionally, changed.

As described below, the method 700 provides ways to present indications of distance and/or direction to a navigation starting location. The method reduces the cognitive burden on a user when interacting with a user interface of the computer system of the disclosure, thereby creating a more efficient human-machine interface. For battery-operated computer systems, increasing the efficiency of the user's interaction with the user interface conserves power and increases the time between battery charges.

In some embodiments, method 700 is performed at a computer system (e.g., 500) in communication with one or more input devices and one or more output devices. For example, the computer system is a mobile computer system (e.g., a tablet, a smartphone, a media player, or a wearable computer system) including wireless communication circuitry, optionally in communication with one or more of a mouse (e.g., external), trackpad (optionally integrated or external), touchpad (optionally integrated or external), remote control computer system (e.g., external), another mobile computer system (e.g., separate from the computer system), a handheld computer system (e.g., external), and/or a controller (e.g., external). In some embodiments, the computer system is a computer system. In some embodiments, the computer system is tablet, phone, laptop, desktop, a head mounted display (“HMD”), computer system with a mechanical wheelbase, self-propelled computer system, smart speaker, personal assistive computer system, robot, and/or camera. In some embodiments, the one or more output devices includes a display generation component. In some embodiments, the display generation component is a display integrated with the computer system (optionally a touch screen display), external display such as a monitor, projector, television, or a hardware component (optionally integrated or external) for projecting a user interface or causing a user interface to be visible to one or more users.

In some embodiments, such as in FIG. 6C, the computer system (e.g., 500) receives (702), via the one or more input devices, a request (e.g., including contact 603c) to present navigation directions from a first physical location to a second physical location. In some embodiments, the request includes selection of an option displayed via a display generation component in communication with the computer system. In some embodiments, the first physical location is selected by the user. For example, the user provides a starting location or starting address for the navigation in a maps or navigation application user interface displayed by the computer system. In some embodiments, the first physical location is automatically selected by the computer system. For example, the first physical location is the location of the computer system when the input for presenting the navigation directions in the maps or navigation application user interface is received. In some embodiments, the first physical location is a location proximate to, but not the same as, the current location of the computer system. For example, the current location of the computer system is a location for which the map does not include paths, roads, walkways, or other means of navigation to the second physical location and the first physical location is a location for which the map includes paths, roads, walkways, or other means of navigation to the second physical location. For example, if the current location of the computer system is inside a park, building, or other area for which the map does not include paths, roads, walkways, or other means of navigation to surrounding paths, roads, walkways, or other means of navigation, the computer system selects a physical location (for the first location) proximate to the park, building, or other area that is connected to paths, roads, walkways, or other means of navigation, such as an entrance or driveway of the park, building, or other area. Thus, the computer system optionally provides guidance for the user to make their way from the current location to the first location (e.g., the start of the navigation directions) as described below. In some embodiments, the trajectory or trajectories followed by the user/computer system from the current location to the first location are not part of the navigation directions presented by the computer system in response to receiving the input for navigation (e.g., the navigation directions do not include display or presentation of a path from the current location to the first location).

In some embodiments, in response to receiving the request (e.g., including contact 603c) to present the navigation directions (704), such as in FIG. 6C, in accordance with a determination that a current location of the computer system (e.g., 500) is greater than a threshold distance from the first physical location, the computer system (e.g., 500) presents (706), via the one or more output devices, at least one orientation cue (e.g., 622a) to orient a user of the computer system from the current location to the first physical location, such as in FIG. 6D. In some embodiments, the threshold distance is a margin of error of a localization sensor (e.g., GPS) in communication with the computer system. In some embodiments, the threshold distance is 0.5, 1, 2, 3, 4, 5, or 10 meters. In some embodiments, the orientation cue includes an audio indication presented via speakers, headphones, or another audio output device included in the one or more output devices described in more detail below. In some embodiments, the orientation cue includes a haptic or tactile output presented via a tactile or haptic output device included in the one or more output devices described in more detail below. In some embodiments, in accordance with the determination that the current location of the computer system is greater than the threshold distance from the first physical location, the computer system presents a visual indication of a portion of the navigation directions (e.g., a portion indicating the first physical location) without initiating navigation along the navigation directions.

In some embodiments, in response to receiving the request (e.g., including contact 603c) to present the navigation directions (704), such as in FIG. 6C, in accordance with a determination that the current location of the computer system (e.g., 500) is within the threshold distance of the first physical location, the computer system (e.g., 500) forgoes (708) presenting the orientation cue, such as in FIG. 6I. In some embodiments, in accordance with the determination that the current location of the computer system is less than the threshold distance from the first physical location, the computer system presents a visual indication of a portion of the navigation directions (e.g., a portion indicating a maneuver included in the navigation directions) while initiating navigation along the navigation directions. In some embodiments, after the computer system reaches the first physical location and while the computer system performs navigation according to the navigation directions, the computer system updates the indication of the navigation directions to present a visual indication of a next maneuver of the navigation directions in response to a respective maneuver being performed. Presenting an indication of the distance between the current location and the first physical location enhances user interactions with the computer system by providing improved feedback to the user to start navigation, such as assisting visually-impaired users with traveling to a starting point of a navigation route.

In some embodiments, such as in FIG. 6D, presenting the orientation cue (e.g., 622a) is in accordance with a determination that a setting is active on the computer system (e.g., 500). In some embodiments, the setting is an accessibility setting of a maps application that presents the navigation directions. In some embodiments, the setting causes the computer system to present the orientation cue in response to the input to present the navigation directions from the first physical location to the second physical location in accordance with the determination that the current location of the computer system is further than the threshold distance from the first physical location.

In some embodiments, such as in FIG. 6K, in accordance with the determination that the current location of the computer system (e.g., 500) is greater than the threshold distance from the first physical location and in accordance with a determination that the setting is not active on the computer system (e.g., 500), the computer system (e.g., 500) forgoes presenting the orientation cue. Selectively presenting the orientation cue depending on whether or not the setting is active on the computer system enhances user interactions with the computer system by providing enhanced feedback to the user when the setting is active and saving processing power and/or battery life when the setting is not active.

In some embodiments, such as in FIG. 6D, in response to receiving the request to present the navigation directions, the computer system (e.g., 500) displays, via a display generation component (e.g., 504) in communication with the computer system (e.g., 500), an indication (e.g., 616) of a navigation route from the first physical location to the second physical location. In some embodiments, the indication of the navigation route includes a map that includes a visual indication of the first physical location and a visual indication of the location of the computer system. In some embodiments, the indication of the navigation route includes a list of a navigation maneuvers (e.g., turns and/or merging onto other roads) from the first physical location to the second physical location. In some embodiments, the navigation route does not include a portion between the current location of the computer system and the first physical location. In some embodiments, the map is a representation of a physical region that includes the current location of the computer system and the visual indication of the first location. In some embodiments, the map further includes at least a portion of a visual indication of the navigation route. In some embodiments, the visual indication of the current location of the computer system includes a visual indication of the orientation of the computer system relative to the physical region represented by the map. In some embodiments, the computer system concurrently displays the map and presents the orientation cue. Displaying the map including the visual indication of the first physical location and the visual indication of the current location of the computer system enhances user interactions with the computer system by providing improved visual feedback to the user.

In some embodiments, such as in FIG. 6I, in response to receiving the request to present the navigation directions, in accordance with the determination that the current location of the computer system (e.g., 500) is within the threshold distance of the first physical location, the computer system (e.g., 500) initiates navigation from the first physical location to the second physical location according to the navigation directions. In some embodiments, initiating navigation includes presenting a visual and/or audio indication of an upcoming maneuver included in the navigation directions that was not presented while the current location of the computer system was greater than the threshold distance from the first physical location. For example, the upcoming maneuver is a turn included in the navigation directions to be made after moving a predefined distance according to the navigation directions away from the first physical location. Initiating navigation from the first physical location to the second physical location in response to receiving the request to present the navigation directions enhances user interactions with the computer system by providing improved feedback to the user.

In some embodiments, in response to receiving the request to present the navigation directions and in accordance with the determination that the current location of the computer system (e.g., 500) is greater than the threshold distance from the first physical location, such as in FIG. 6D, in accordance with a determination that the current location of the computer system (e.g., 500) is a first distance from the first physical location, the orientation cue (e.g., 622a) has a characteristic having a first value. In some embodiments, the orientation cue includes tactile and/or audio pulses and the characteristic is a period of time between the tactile and/or audio pulses that corresponds to the distance between the computer system and the first physical location. In some embodiments, the first value is a first period of time between the pulses. In some embodiments, the characteristic is a pitch, tone, or timbre of audio pulses and/or a texture or sharpness of tactile pulses.

In some embodiments, in response to receiving the request to present the navigation directions and in accordance with the determination that the current location of the computer system (e.g., 500) is greater than the threshold distance from the first physical location, such as in FIG. 6G, in accordance with a determination that the current location of the computer system (e.g., 500) is a second distance different from the first distance from the first physical location, the orientation cue (e.g., 622d) has the characteristic having a second value different from the first value. In some embodiments, the second value is a second period of time between the haptic and/or audio pulses. In some embodiments, if the first distance is greater than the second distance, the first period of time is greater than the second period of team. In some embodiments, if the first distance is less than the second distance, the first period of time is greater than the second period of team. In some embodiments, as the distance between the computer system and the first physical location changes (e.g., due to movement of the computer system), the value of the characteristic gradually changes accordingly. Changing a characteristic of the orientation cue in accordance with the distance between the current location of the computer system and the first physical location enhances user interactions with the computer system by providing improved feedback to the user.

In some embodiments, such as in FIG. 6G, the orientation cue (e.g., 622d) includes audio pulses (e.g., 6240 and the characteristic is a time period between the audio pulses. In some embodiments, as the distance between the current location of the computer system and the first physical location changes, the period of time between audio and/or tactile pulses changes accordingly. For example, as the computer system moves closer to the first physical location, the period of time between pulses decreases and as the computer system moves further from the first physical location, the period of time between pulses increases. Changing the duration of time between audio pulses in accordance with the distance between the current location of the computer system and the first physical location enhances user interactions with the computer system by providing improved feedback to the user.

In some embodiments, in response to receiving the request to present the navigation directions and in accordance with the determination that the current location of the computer system (e.g., 500) is greater than the threshold distance from the first physical location, in accordance with a determination that the current location of the computer system (e.g., 500) is greater than a second threshold distance (e.g., 622) greater than the threshold distance from the first physical location, such as in FIG. 6G, the orientation cue (e.g., 622d) has a second characteristic different from the first characteristic having a first value. In some embodiments, the second threshold is a threshold distance at which the user may be able to see the first physical location. In some embodiments, the second threshold distance is 1, 2, 3, 4, 5, 6, 10, 15, 25, or 50 meters. In some embodiments, the first characteristic is a period of time between tactile and/or audio pulses. In some embodiments, the second characteristic is a pitch, tone, or timber of the audio pulses and/or a sharpness or texture of tactile pulses. In some embodiments, the second threshold distance defines a sphere of accuracy around the first physical location. In some embodiments, the sphere of accuracy is a geofenced region defined using one or more of GPS and/or RFID and/or similar technology.

In some embodiments, in response to receiving the request to present the navigation directions and in accordance with the determination that the current location of the computer system (e.g., 500) is greater than the threshold distance from the first physical location, in accordance with a determination that the current location of the computer system (e.g., 500) is less than the second threshold distance (e.g., 622) from the first physical location, such as in FIG. 6H, the orientation cue (e.g., 622e) has the second characteristic having a second value different from the first value. In some embodiments, the second characteristic has a binary value and the first characteristic has more than two possible values. For example, if the current location of the computer system is a first distance greater than the second threshold from the first physical location, the orientation cue has the first characteristic with a first value and the second characteristic with the first value; if the current location of the computer system is a second distance greater than the second threshold from the first physical location, the orientation cue has the first characteristic with a second value and the second characteristic with the first value; if the current location of the computer system is a third distance less than the second threshold but greater than the first threshold from the first physical location, the orientation cue has the first characteristic with a third value and the second characteristic with the second value; and if the current location of the computer system is a fourth distance less than the second threshold but greater than the first threshold from the first physical location, the orientation cue has the first characteristic with a fourth value and the second characteristic with the second value. Presenting the orientation cue with the second characteristic having a different value depending on whether the current location is greater than or less than the second threshold enhances user interactions with the computer system by providing improved feedback to the user.

In some embodiments, such as in FIG. 6H, the orientation cue (e.g., 622e) includes tactile pulses (e.g., 624g) and the characteristic is a time period between the tactile pulses (e.g., 624g). In some embodiments, the computer system presents tactile pulses without presenting audio pulses. In some embodiments, the computer system concurrently presents the tactile pulses and audio pulses. In some embodiments, the tactile and audio pulses are presented in a synchronized manner. In some embodiments, the computer system presents audio pulses without presenting tactile pulses. Presenting the orientation cue including tactile pulses enhances user interactions with the computer system by providing improved feedback to the user.

In some embodiments, in response to receiving the request to present the navigation directions, such as in FIG. 6C, and in accordance with the determination that the current location of the computer system (e.g., 500) is greater than the threshold distance from the first physical location, the computer system (e.g., 500) detects a change in bearing of the computer system relative (e.g., 500) to the first location, such as in FIG. 6E. In some embodiments, the bearing is an angle between (1) a straight line between the first physical location and the computer system and (2) a direction in which a predetermined portion (e.g., the top edge of the display) of the computer system is facing. For example, when the user turns right or left while holding the computer system in a predetermined orientation relative to the body of the user, the bearing of the computer system changes.

In some embodiments, in response to receiving the request to present the navigation directions, such as in FIG. 6C, and in accordance with the determination that the current location of the computer system (e.g., 500) is greater than the threshold distance from the first physical location, in response to detecting the change in the bearing of the computer system (e.g., 500) relative to the first location, in accordance with a determination that the change in bearing of the computer system (e.g., 500) relative to the first location includes the bearing of the computer system (e.g., 500) relative to the first physical location changing from the bearing of the computer system (e.g., 500) being outside of a predefined range of orientations (e.g., 626) to being inside the predefined range of orientations (e.g., 626), such as in FIG. 6E, the computer system (e.g., 500) presents a second orientation cue (e.g., 624c) when the computer system (e.g., 500) is positioned at a threshold angle of the predefined range of orientations (e.g., 626). In some embodiments, the predefined range of orientations includes an angle (e.g., 1, 2, 3, 5, 10, 15, 30, or 45 degrees) that includes an orientation in which the predefined portion of the computer system is oriented towards the first physical location. In some embodiments, the second orientation cue is a tactile and/or audio indication that has a different characteristic from the first orientation cue. For example, the first orientation cue and second orientation cue include tactile indications with different patterns, textures, sharpnesses, and/or durations and/or the first indication and/or the first indication and second indication include audio indications with different timbres, pitches, tones, durations and/or sounds. In some embodiments, presenting the second orientation cue indicates that the computer system is positioned within the predefined range of orientations.

In some embodiments, in response to receiving the request to present the navigation directions, such as in FIG. 6C, and in accordance with the determination that the current location of the computer system (e.g., 500) is greater than the threshold distance from the first physical location, in response to detecting the change in the bearing of the computer system (e.g., 500) relative to the first location, in accordance with a determination that the change in bearing of the computer system (e.g., 500) relative to the first location includes the bearing of the computer system (e.g., 500) relative to the first physical location changing from the bearing of the computer system (e.g., 500) being inside the predefined range of orientations (e.g., 626) to being outside of the predefined range of orientations (e.g., 626), such as in FIG. 6F, presenting a third orientation cue (e.g., 624e) when the computer system (e.g., 500) is positioned at the threshold of the predefined range of orientations (e.g., 626). In some embodiments, the third orientation cue is a tactile and/or audio indication that has a different characteristic from the first orientation cue. For example, the first orientation cue and third orientation cue include tactile indications with different patterns, textures, sharpnesses, and/or durations and/or the first orientation cue and/or the first orientation cue and third orientation cue include audio indications with different timbres, pitches, tones, durations and/or sounds. In some embodiments, the second and third orientation cues are the same. In some embodiments, the second and third orientation cues are different. In some embodiments, presenting the third orientation cue indicates that the computer system is positioned outside of the predefined range of orientations. In some embodiments, in response to detecting a change in bearing of the computer system from a first orientation outside of the predefined range to a second orientation outside the predefined range of orientations, the computer system forgoes presenting the second or third orientation cue. In some embodiments, in response to detecting a change in bearing of the computer system from a first orientation within the predefined range of orientations to a second orientation within the predefined range of orientations, the computer system forgoes presenting the second or third orientation cues. Presenting the second and third orientation cues enhances user interactions with the computer system by providing improved feedback to assist the user in reaching the first physical location.

In some embodiments, such as in FIGS. 6E-6F, the second orientation cue (e.g., 624c) has a first intensity and the third orientation cue (e.g., 624e) has a second intensity different from the first intensity. In some embodiments, the second and third orientation cues include audio indications and the intensities are volumes. In some embodiments, the second and third orientation cues include tactile indications and the intensities are magnitudes of the tactile indications. Presenting the second and third orientation cues with different intensities enhances user interactions with the computer system by providing improved feedback to assist the user in reaching the first physical location.

In some embodiments, in response to receiving the request to present the navigation directions, such as in FIG. 6C, and in accordance with the determination that the current location of the computer system (e.g., 500) is greater than the threshold distance from the first physical location, in accordance with a determination that a bearing of the computer system (e.g., 500) relative to the first location is within a predefined range of orientations (e.g., 626), such as in FIG. 6D, the orientation cue (e.g., 622a) has a characteristic having a first value. In some embodiments, the bearing of the computer system and the predefined range of orientations are described in more detail above. In some embodiments, the characteristic is independent from a second characteristic that depends on the distance between the computer system and the first physical location (e.g., the duration between audio and/or tactile pulses) described above. For example, the characteristic is a pitch or tone of an audio pulse and/or a texture and/or sharpness of a tactile pulse and the second characteristic is a duration of time between pulses.

In some embodiments, in response to receiving the request to present the navigation directions, such as in FIG. 6C, and in accordance with the determination that the current location of the computer system (e.g., 500) is greater than the threshold distance from the first physical location, in accordance with a determination that the bearing of the computer system (e.g., 500) relative to the first location is within the predefined range of orientations (e.g., 626), such as in FIG. 6G, the orientation cue (e.g., 622d) has the characteristic having a second value different from the first value. Presenting the orientation cue with a characteristic having different values depending on whether or not the bearing of the computer system relative to the first location is within the predefined range of orientations enhances user interactions with the computer system by providing improved feedback to assist the user in reaching the first physical location.

In some embodiments, in response to receiving the request to present the navigation directions, such as in FIG. 6C, and in accordance with the determination that the current location of the computer system (e.g., 500) is greater than the threshold distance from the first physical location, while the distance between the computer system (e.g., 500) and the first physical location is a first distance, a bearing of the computer system (e.g., 500) relative to the first physical location is a first orientation and there is a physical occlusion (e.g., 638) between the computer system and the first physical location, such as in FIG. 6G, the orientation cue (e.g., 622d) has a first set of characteristics. In some embodiments, the characteristics of the orientation cue include a characteristic that indicates the distance between the computer system and the first physical location and/or a characteristic that indicates whether or not the bearing of the computer system is within a predefined range of orientations relative to the first physical location, as described above. In some embodiments, the first set of characteristics are independent from whether or not there is a physical occlusion between the computer system and the first physical location. In some embodiments, the physical occlusion is a physical object that prevents the user from reaching the first physical location along a straight line path. For example, the physical occlusion is a wall, a building, a body of water, a vehicle, or a tree.

In some embodiments, in response to receiving the request to present the navigation directions, such as in FIG. 6C, and in accordance with the determination that the current location of the computer system (e.g., 500) is greater than the threshold distance from the first physical location, while the distance between the computer system (e.g., 500) and the first physical location is the first distance, the bearing of the computer system (e.g., 500) relative to the first physical location is the first orientation and there is not the physical occlusion between the computer system (e.g., 500) and the first physical location, such as in FIG. 6G if occlusion 638 were not present, the orientation cue (e.g., 622d) has the first set of characteristics. In some embodiments, the orientation cue has the same characteristics whether or not there is a physical occlusion between the computer system and the first physical location. In some embodiments, the computer system is unable to detect physical occlusions between the current location of the computer system and the first physical location. Presenting an orientation cue of the distance between the current location and the first physical location enhances user interactions with the computer system by providing improved feedback to the user to start navigation, such as assisting visually-impaired users with traveling to a starting point of a navigation route.

In some embodiments, in response to receiving the request to present the navigation directions, such as in FIG. 6C, in accordance with the determination that the computer system is within the threshold distance of the first physical location, such as in FIG. 6I, when the request to present the navigation directions is received, the computer system (e.g., 500) presents the navigation directions (e.g., from the current location of the computer system and/or the first location to the second location) without presenting the orientation cue. In some embodiments, the computer system forgoes presenting the orientation cue if the navigation directions start at the current location of the computer system. Forgoing presenting the orientation cue orientation cue in accordance with the determination that the computer system is within the predefined threshold distance of the first physical location enhances user interactions with the computer system by reducing the processing power and/or battery life used in response to detecting the request to present the navigation directions.

In some embodiments, in response to receiving the request to present the navigation directions, such as in FIG. 6C, and in response to the current location of the computer system (e.g., 500) transitioning from being greater than the threshold distance from the first physical location, such as in FIG. 6H, to the current location of the computer system (e.g., 500) being within the threshold distance of the first physical location, such as in FIG. 6I, the computer system (e.g., 500) transitions from presenting the orientation cue (e.g., 622e) without presenting the navigation directions, such as in FIG. 6H, to presenting the navigation directions (e.g., 640a and/or 628c) without presenting the orientation cue, such as in FIG. 6I. In some embodiments, the orientation cue includes audio and/or tactile pulses described in more detail above that are not included in the navigation directions. In some embodiments, presenting the navigation directions includes presenting visual indications of maneuvers included in the navigation directions including text and/or symbols and/or audio indications that include speech not included in the orientation cue. In some embodiments, the orientation cue is different from the navigation directions. In some embodiments, the orientation cue indicates the distance between the computer system and the first physical location, optionally whether or not the bearing of the computer system is within the predefined range of orientations relative to the first physical location without indicating turns (and/or other driving, walking, cycling, transit or other maneuvers) to take to reach the first physical location. In some embodiments, the navigation directions include an indication of the distance along the route between the computer system and the second physical location without including an indication of direct distance between the computer system and the second physical location and including turns (and/or other driving, walking, cycling, transit or other maneuvers) to take along the navigation route to reach the second physical location, including distance between the computer system and the location of the next turn (and/or other driving, walking, cycling, transit or other maneuvers) to take. In some embodiments, while the computer system presents the navigation directions, in response to detecting movement of the computer system completing a respective maneuver of the navigation route, the computer system presents an indication of a next maneuver of the navigation route. In some embodiments, while the computer system presents the navigation directions, in response to detecting movement of the computer system that misses a respective maneuver of the navigation route (e.g., going straight instead of taking a turn included in the navigation route), the computer system presents a next maneuver to resume navigating along the navigation route. Transitioning from presenting the orientation cue to presenting the navigation directions to the second physical location in response to the current location of the computer system being within the threshold distance of the first physical location enhances user interactions with the computer system by providing improved feedback to the user to reach the first physical location and then navigate to the second physical location.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 7 are, optionally, implemented by components depicted in FIGS. 1A-1B. For example, receiving operation 702 and presenting operation 706 are, optionally, implemented by event sorter 170, event recognizer 180, and event handler 190. Event monitor 171 in event sorter 170 detects a contact on touch screen 504, and event dispatcher module 174 delivers the event information to application 136-1. A respective event recognizer 180 of application 136-1 compares the event information to respective event definitions 186, and determines whether a first contact at a first location on the touch screen corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology is the gathering and use of data available from specific and legitimate sources to improve the ability for users to track and locate items or computer systems that may be of interest to them. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, location data can be used for navigation purposes. Accordingly, use of such personal information data enables users to navigate to physical locations. Further, other uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide personal data and/or computer system or object location data. In yet another example, users can select to limit the length of time personal data and/or computer system or object location data is maintained or entirely block the development of a baseline location profile. In addition to providing “opt in” and “opt out” options, the present disclosure contemplates providing notifications relating to the access or use of personal information. For instance, a user may be notified upon downloading an application that their personal information data and/or location data will be accessed and then reminded again just before personal information data is accessed by the application.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, location data and notifications can be delivered to users based on aggregated non-personal information data or a bare minimum amount of personal information.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
at a computer system in communication with one or more input devices and one or more output devices:
receiving, via the one or more input devices, a request to present navigation directions from a first physical location to a second physical location; and
in response to receiving the request to present the navigation directions:
in accordance with a determination that a current location of the computer system is greater than a threshold distance from the first physical location, presenting, via the one or more output devices, at least one orientation cue to orient a user of the computer system from the current location to the first physical location; and
in accordance with a determination that the current location of the computer system is within the threshold distance of the first physical location, forgoing presenting the orientation cue.

2. The method of claim 1, wherein presenting the orientation cue is in accordance with a determination that a setting is active on the computer system, and the method further comprises:
in accordance with the determination that the current location of the computer system is greater than the threshold distance from the first physical location and in accordance with a determination that the setting is not active on the computer system, forgoing presenting the orientation cue.

3. The method of claim 1, further comprising:
in response to receiving the request to present the navigation directions:
displaying, via a display generation component in communication with the computer system, an indication of a navigation route from the first physical location to the second physical location.

4. The method of claim 1, further comprising:
in response to receiving the request to present the navigation directions:
in accordance with the determination that the current location of the computer system is within the threshold distance of the first physical location, initiating navigation from the first physical location to the second physical location according to the navigation directions.

5. The method of claim 1, wherein:
in response to receiving the request to present the navigation directions and in accordance with the determination that the current location of the computer system is greater than the threshold distance from the first physical location:
in accordance with a determination that the current location of the computer system is a first distance from the first physical location, the orientation cue has a characteristic having a first value, and
in accordance with a determination that the current location of the computer system is a second distance different from the first distance from the first physical location, the orientation cue has the characteristic having a second value different from the first value.

6. The method of claim 5, wherein the orientation cue includes audio pulses and the characteristic is a time period between the audio pulses.

7. The method of claim 6, wherein:
in response to receiving the request to present the navigation directions and in accordance with the determination that the current location of the computer system is greater than the threshold distance from the first physical location:
in accordance with a determination that the current location of the computer system is greater than a second threshold distance greater than the threshold distance from the first physical location, the orientation cue has a second characteristic different from the first characteristic having a first value, and
in accordance with a determination that the current location of the computer system is less than the second threshold distance from the first physical location, the orientation cue has the second characteristic having a second value different from the first value.

8. The method of claim 5, wherein the orientation cue includes tactile pulses and the characteristic is a time period between the tactile pulses.

9. The method of claim 1, further comprising:
in response to receiving the request to present the navigation directions and in accordance with the determination that the current location of the computer system is greater than the threshold distance from the first physical location:
detecting a change in bearing of the computer system relative to the first location; and
in response to detecting the change in the bearing of the computer system relative to the first location:
in accordance with a determination that the change in bearing of the computer system relative to the first location includes the bearing of the computer system relative to the first physical location changing from the bearing of the computer system being outside of a predefined range of orientations to being inside the predefined range of orientations, presenting a second orientation cue when the computer system is positioned at a threshold angle of the predefined range of orientations; and
in accordance with a determination that the change in bearing of the computer system relative to the first location includes the bearing of the computer system relative to the first physical location changing from the bearing of the computer system being inside the predefined range of orientations to being outside of the predefined range of orientations, presenting a third orientation cue when the computer system is positioned at the threshold of the predefined range of orientations.

10. The method of claim 9, wherein the second orientation cue has a first intensity and the third orientation cue has a second intensity different from the first intensity.

11. The method of claim 1, wherein:
in response to receiving the request to present the navigation directions and in accordance with the determination that the current location of the computer system is greater than the threshold distance from the first physical location:
in accordance with a determination that a bearing of the computer system relative to the first location is within a predefined range of orientations, the orientation cue has a characteristic having a first value; and
in accordance with a determination that the bearing of the computer system relative to the first location is within the predefined range of orientations, the orientation cue has the characteristic having a second value different from the first value.

12. The method of claim 1, wherein:
in response to receiving the request to present the navigation directions and in accordance with the determination that the current location of the computer system is greater than the threshold distance from the first physical location:
while the distance between the computer system and the first physical location is a first distance, a bearing of the computer system relative to the first physical location is a first orientation and there is a physical occlusion between the computer system and the first physical location, the orientation cue has a first set of characteristics, and
while the distance between the computer system and the first physical location is the first distance, the bearing of the computer system relative to the first physical location is the first orientation and there is not the physical occlusion between the computer system and the first physical location, the orientation cue has the first set of characteristics.

13. The method of claim 1, further comprising:
in response to receiving the request to present the navigation directions:
in accordance with the determination that the computer system is within the threshold distance of the first physical location when the input corresponding to the request to present the navigation directions is received, presenting the navigation directions without presenting the orientation cue.

14. The method of claim 1, further comprising:
in response to receiving the request to present the navigation directions, and in response to the current location of the computer system transitioning from being greater than the threshold distance from the first physical location to the current location of the computer system being within the threshold distance of the first physical location:
transitioning from presenting an indication of the distance between the current location of the computer system and the first physical location without presenting the navigation directions to presenting the navigation directions without presenting the orientation cue.

15. A computer system, comprising:
one or more processors;
memory; and
one or more programs, wherein the one or more programs are stored in the memory and configured to be executed by the one or more processors, the one or more programs including instructions for:
receiving, via one or more input devices, a request to present navigation directions from a first physical location to a second physical location; and
in response to receiving the request to present the navigation directions:
in accordance with a determination that a current location of the computer system is greater than a threshold distance from the first physical location, presenting, via one or more output devices, at least one orientation cue to orient a user of the computer system from the current location to the first physical location; and
in accordance with a determination that the current location of the computer system is within the threshold distance of the first physical location, forgoing presenting the orientation cue.

16. A non-transitory computer readable storage medium storing one or more programs, the one or more programs comprising instructions, which when executed by one or more processors of a computer system, cause the computer system to perform a method comprising:
receiving, via one or more input devices, a request to present navigation directions from a first physical location to a second physical location; and
in response to receiving the request to present the navigation directions:
in accordance with a determination that a current location of the computer system is greater than a threshold distance from the first physical location, presenting, via one or more output devices, at least one orientation cue to orient a user of the computer system from the current location to the first physical location; and
in accordance with a determination that the current location of the computer system is within the threshold distance of the first physical location, forgoing presenting the orientation cue.
